(19) United States
(12) Patent Application Publication
(10) Pub. No.: US 2024/0162505 A1
(43) Pub. Date: May 16, 2024

(54) ENERGY STORAGE DEVICES WITH AQUEOUS ELECTROLYTES AND COMPONENTS THEREFOR

(71) Applicant: Alsym Energy, Inc., Woburn, MA (US)

(72) Inventors: Christopher Ryan Marsh, Waltham, MA (US); Robert William Atkinson, III, Winchester, MA (US); Daniel Anthony Evans, Melrose, MA (US); Nellymar Membreno, Billerica, MA (US); Rahul Mukherjee, Winchester, MA (US); Alolika Mukhopadhyay, Wilmington, MA (US); Blayne Phillips, Wilmington, MA (US); Kripa Varanasi, Lexington, MA (US)

(21) Appl. No.: 18/389,448

(22) Filed: Nov. 14, 2023

Related U.S. Application Data
(60) Provisional application No. 63/425,253, filed on Nov. 14, 2022.

(51) Int. Cl. H01M 10/42; H01M 4/133; H01M 4/134; H01M 4/62; H01M 4/66; H01M 10/52

(52) U.S. Cl. CPC H01M 10/4235; H01M 4/133; H01M 4/134; H01M 4/628; H01M 4/663; H01M 4/667; H01M 10/523; H01M 2300/0002

(57) ABSTRACT

Described herein are, inter alia, electrodes for use in energy storage devices, such as a cathode or anode in a battery. An electrode may include a substrate which serves as a reaction site that occur during electrochemical cycling of an energy storage device. In some embodiments, an electrode can undergo intercalation chemistry, conversion chemistry, plating-stripping/deposition-dissolution chemistry, or combinations thereof. A film and/or additive may be provided in an electrode in order to mitigate side reactions and/or electrochemical passivation reactions. An electrode may include one or more materials that (i) electrochemically reduce a portion of the electrolyte to a gas during electrochemical cycling, (ii) suppress generation of hydrogen gas by increasing a hydrogen evolution overpotential, (iii) constrain gas after formation, and/or (iv) catalyze oxidation of a gas back into an electrolyte. An electrode may include one or more electroactive materials in addition to a substrate.

### CROSS-REFERENCE TO RELATED APPLICATIONS

This application claims priority to and benefit of U.S. Provisional Application No. 63/425,253, filed on Nov. 14, 2022, the entire contents of which are hereby incorporated by reference.

### TECHNICAL FIELD

This disclosure relates generally to electrodes for energy storage devices. In some embodiments, the energy storage devices are aqueous secondary batteries.

### BACKGROUND

Energy storage devices, such as electrochemical cells, generally include two electrodes (an anode and a cathode), a separator, and an electrolyte. These few components nonetheless present a complex electrochemical environment. The complex electrochemical environment can mar the performance of the electrochemical cell, for example through the occurrence of undesirable side reactions and/or electrochemical passivation, either at one or more of the electrodes, in the electrolyte, or between one or more of the electrodes and the electrolyte. There is a need, therefore, for electrode compositions that mitigate such undesirable side reactions and/or electrochemical passivation and/or promote electrochemical stability and/or kinetics in an energy storage device, such as an aqueous secondary battery.

### SUMMARY

Described herein are, inter alia, electrodes for use in energy storage devices, such as a cathode or anode in a battery. An electrode may include a substrate (e.g., a conductive substrate) which serves as a reaction site, for example for redox reactions, that occur during electrochemical cycling of an energy storage device. In some embodiments, an electrode can undergo intercalation chemistry, conversion chemistry, plating-stripping/deposition-dissolution chemistry, or combinations thereof. For example, material (e.g., one or more species) may plate and strip or deposit and dissolve during electrochemical cycling of an energy storage device. A film (e.g., coating) and/or additive may be provided in an electrode in order to mitigate side reactions and/or electrochemical passivation reactions. An electrode may include one or more materials that (i) electrochemically reduce a portion of the electrolyte to a gas during electrochemical cycling, (ii) suppress generation of hydrogen gas by increasing a hydrogen evolution overpotential, (iii) constrain gas after formation, and/or (iv) catalyze oxidation of a gas back into an electrolyte. An electrode may include one or more electroactive materials in addition to a substrate (e.g., current collector) or not.

In some aspects, the present disclosure is directed to a battery comprising: two electrodes comprising an anode and a cathode, an electrolyte, and a separator disposed to prevent direct physical contact of the anode and the cathode, wherein the separator comprises an ion-uptake-and-release material.

In some embodiments, the ion-uptake-and-release material can take up and release ions of titanium, vanadium, chromium, manganese, magnesium, lithium, sodium, potassium, iron, cobalt, nickel, copper, zinc, gallium, hydrogen, zirconium, niobium, molybdenum, ruthenium, silver, cadmium, indium, tin, antimony, lanthanum, cerium, neodymium, tantalum, tungsten, strontium, or bismuth, or a hydroxide, an oxide-hydroxide, a nitrate, a sulfate, a phosphate, or a halide, or a combination thereof.

In some aspects, the present disclosure is directed to a battery comprising: two electrodes comprising an anode and a cathode, an electrolyte, and a separator disposed to prevent direct physical contact of the anode and the cathode, wherein the separator has been directly deposited onto one or both of the two electrodes (e.g., ex situ or in situ) or calendared onto one or both of the two electrodes, or both deposited and calendared onto one or both of the two electrodes (e.g., such that the separator has one or more of one or more of improved ionic conductivity, improved insulation, and better wettability).

In some aspects, the present disclosure is directed to a battery comprising: two electrodes comprising an anode and a cathode, an electrolyte, and a separator disposed to prevent direct physical contact of the anode and the cathode, wherein at least one of the two electrodes comprises particles, wherein the particles (i) comprise two or more materials that form a composite, (ii) are at least partially (e.g., fully) encapsulated by one or more materials (e.g., different from one or more materials of the particles), or (iii) both (i) and (ii). In some embodiments, the particles (i) comprise two or more materials that form a composite. In some embodiments, the particles (ii) are at least partially (e.g., fully) encapsulated by one or more materials (e.g., different from one or more materials of the particles). In some embodiments, the at least one of the two electrodes comprises secondary particles formed with the particles. In some embodiments, the particles are disposed (e.g., dispersed) in a matrix. In some embodiments, the particles comprise a solid mixture and the solid mixture is at least partially (e.g., fully) encapsulated by one or more materials. In some embodiments, the one or more materials comprise a material that is different from any material in the solid mixture.

In some aspects, the present disclosure is directed to a battery comprising: two electrodes comprising an anode and a cathode, an electrolyte, and a separator disposed to prevent direct physical contact of the anode and the cathode, wherein the electrolyte transfers ions between one or both of the electrodes during electrochemical cycling of the battery. In some embodiments, (i) the two electrodes exchange (e.g., only) one or more same types of ions (e.g., aluminum ions, sulfur ions, hydrogen ions, or a combination thereof) with the electrolyte as each other during the electrochemical cycling (e.g., wherein ions do not travel from one of the two electrodes to the other of the two electrodes during electrochemical cycling), (ii) the two electrodes exchange (e.g., only) one or more different types of ions (e.g., aluminum ions, sulfur ions, or hydrogen ions) with the electrolyte from each other during the electrochemical cycling (e.g., wherein ions do not travel from one of the two electrodes to the other of the two electrodes during electrochemical cycling), or (iii) a combination of (i) and (ii) (e.g., at least one same type and at least one different type). In some embodiments, the one of the two electrodes is in a relatively less acidic environment at a stage of charge and the other of the two electrodes is in a relatively more acidic environment at the stage of charge. In some embodiments, the relatively less acidic environment is a neutral environment (e.g., having a pH of at least 6 and no higher than 8) or an alkaline environment (e.g., having a pH of higher than 8 or higher than 10) and the relatively more acidic environment is a neutral environment (e.g., having a pH of at least 6 and no higher than 8) or an acidic environment (e.g., having a pH of less than 6 or less than 4).

Any of the following features may be used in a battery according to any of the aforementioned aspects.

In some embodiments, the separator is a free-standing film (e.g., comprising a polymer reinforcement) or has been deposited directly onto at least one of the two electrodes.

In some embodiments, the separator comprises one or more members selected from the group consisting of polyethylene, polypropylene, polyethersulfone, sodium, lithium, potassium, calcium, magnesium, aluminum, an aluminum oxide, a tin oxide, a titanium oxide, a silicon oxide, a silicon carbide, a silicon nitride, a silicon aluminum oxynitride, a zinc oxide, ferrites, cerium, a cerium oxide, hydrogen, water molecules, lanthanum, a lanthanum oxide, boron, a boron oxide, a boron nitride, zirconium, a zirconium oxide, and combinations thereof.

In some embodiments, the separator comprises one or more binders.

In some embodiments, the one or more binders comprise a member selected from the group consisting of polyvinylidene fluoride (PVDF), polytetrafluoroethylene (PTFE), polyvinyl alcohol, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), styrene butadiene rubber (SBR), and nafion.

In some embodiments, the electrolyte comprises one or more ions that are surrounded by solvation shells.

In some embodiments, the electrolyte comprises one or more ions that promote diffusion of at least one other ion into at least one of the two electrodes, wherein the at least one other ion is an electroactive species.

In some embodiments, the electrolyte comprises an additive that (1) promotes hydrogen evolution reaction, (2) impedes hydrogen evolution reaction, (3) promotes oxygen evolution reaction, (4) impedes oxygen evolution reaction, (5) promotes dissolution species from one or both the electrodes, (6) impedes dissolution species from one or both the electrodes, (7) promotes stripping and plating of metal ions, (8) impedes stripping and plating of metal ions, (9) promotes conversion between metals and metal oxides, or (10) impedes conversion between metals and metal oxides.

In some embodiments, at least one of the two electrodes comprises one or more materials selected from the group consisting of: elemental forms of a metal, halides of a metal, hydroxides of a metal, oxides of a metal, phosphates of a metal, suboxides of a metal, nitrates of a metal, nitrites of a metal, sulfates of a metal, sulfides of a metal, chlorates of a metal, bromates of a metal, cyanides of a metal, and iodates of a metal. In some embodiments, the metal is selected from the group consisting of silicon, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, neodymium, tantalum, tungsten, mercury, rhenium, platinum, gold, lead, strontium, bismuth, and combinations thereof.

In some embodiments, at least one of the two electrodes comprises a metal selected from the group consisting of silicon, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, neodymium, tantalum, tungsten, rhenium, platinum, gold, lead, strontium, bismuth, and combinations (e.g., an alloy) thereof.

In some embodiments, at least one of the two electrodes comprises a metal oxide selected from the group consisting of silicon oxides, titanium oxides, vanadium oxides, chromium oxides, manganese oxides, magnesium oxide, lithium oxides, sodium oxides, potassium oxides, iron oxides, cobalt oxides, nickel oxides, copper oxides, zinc oxides, aluminum oxides, gallium oxides, zirconium oxides, niobium oxides, molybdenum oxides, ruthenium oxides, silver oxides, cadmium oxides, indium oxides, tin oxides, antimony oxides, lanthanum oxides, cerium oxides, tantalum oxides, tungsten oxides, lead oxides, strontium oxides, bismuth oxides, ternary oxide comprising one or more of silicon, calcium, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, tantalum, tungsten, lead, strontium, and bismuth, quaternary oxides comprising one or more of silicon, calcium, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, tantalum, tungsten, lead, strontium, and bismuth and combinations thereof.

In some embodiments, at least one of the two electrodes comprises a material comprising one or more additives comprising one or more elements, one or more dopants comprising one or more elements, one or more interstitial alloys comprising one or more elements, one or more interstitial compounds comprising one or more elements, one or more chemical bonds with one or more elements, or one or more physical bonds (e.g., weak van der Waal's forces) with one or more elements. In some embodiments, the one or more elements comprises an element selected from the group consisting of hydrogen, boron, carbon, nitrogen, sodium, potassium, lithium, calcium, sulfur, phosphorus, manganese, magnesium, iron, cobalt, nickel, copper, zinc, aluminum, gallium, zirconium, niobium, molybdenum, ruthenium, cadmium, indium, tin, antimony, lanthanum, cerium, neodymium, tantalum, tungsten, rhenium, platinum, lead, strontium, bismuth, and halides.

In some embodiments, at least one of the two electrodes comprises a material comprising defects, vacancies, moieties, or holes (e.g., pores). In some embodiments, the at least one of the two electrodes has been treated to introduce (e.g., incorporate) the defects, vacancies, moieties, or holes (e.g., pores).

In some embodiments, at least one of the two electrodes comprises a material comprising water molecules and/or one or more anions and/or one or more functional groups with or without a physical or chemical bonding. In some embodiments, the material comprises the one or more anions and the one or more anions comprise a member selected from the group consisting of a phosphate, a sulfate, a sulfide, a nitrate, a nitride, a halide, a hydride, a hydrate, a hydroxide, an oxide, an alkane, an alkene, an alkyne, a phenyl, a phenol, an amine, an amide, an ether, an alkyl halide, a thiol, an aldehyde, an ester, a carboxylic acid, an ester, and an alcohol.

In some embodiments, at least one of the two electrodes comprises one or more material that are crystalline, amorphous, polycrystalline, polymorphous, or a combination thereof.

In some embodiments, at least one of the two electrodes exist in the form of an alloy, a mixed metal oxide, or composite wherein the alloy, the mixed metal oxide, or the composite is formed with one or more members selected from the group consisting of: carbon, a carbide, silicon, a silicon oxide, titanium, a titanium oxide, vanadium, a vanadium oxide, chromium, a chromium oxide, manganese, a manganese oxide, magnesium, a magnesium oxide, lithium, a lithium oxide, sodium, a sodium oxide, potassium, a potassium oxide, iron, an iron oxide, cobalt, a cobalt oxide, nickel, a nickel oxide, copper, a copper oxide, zinc, a zinc oxide, aluminum, an aluminum oxide, gallium, a gallium oxide, zirconium, a zirconium oxide, niobium, a niobium oxide, molybdenum, a molybdenum oxide, ruthenium, a ruthenium oxide, silver, a silver oxide, cadmium, a cadmium oxide, indium, an indium oxide, tin, a tin oxide, antimony, an antimony oxide, lanthanum, a lanthanum oxide, cerium, a cerium oxide, neodymium, tantalum, a tantalum oxide, tungsten, a tungsten oxide, rhenium, platinum, gold, lead, a lead oxide, strontium, strontium oxide, bismuth, and a bismuth oxide.

In some embodiments, the battery is a secondary battery.

In some embodiments, the electrolyte is an aqueous electrolyte such that the battery is an aqueous battery.

In some aspects, the present disclosure is directed to a method of operating a battery (e.g., an aqueous battery) [e.g., a secondary battery (e.g., an aqueous secondary battery)] comprising an electrode comprising a conductive substrate, the method comprising changing a redox state of a material on the substrate (e.g., at a surface of the substrate) during electrochemical cycling (e.g., charging and/or discharging) of the battery.

In some embodiments, the method comprises depositing and/or dissolving the material on the substrate during the electrochemical cycling (e.g., wherein changing the redox state of the material comprises depositing and/or dissolving the material on the substrate).

In some embodiments, changing the redox state of the material comprises a further electrochemical reaction. In some embodiments, the further electrochemical reaction is selected from the group consisting of conversion from one compound to a second compound (e.g., along with any associate intermediate(s)), monovalent or multivalent monatomic or polyatomic ion storage (e.g., intercalation), and structural rearrangement.

In some embodiments, the material comprises one or more members selected from the group consisting of elemental (e.g., metallic) forms of, oxides of, suboxides of, oxychlorides of, oxynitrates of, hydroxides of, hydrides of, carbides of, sulfides of, halides of, and oxide hydroxides of one or more elements, wherein the one or more elements are selected from the group consisting of titanium, vanadium, chromium, manganese, iron, aluminum, silicon, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, lead, and bismuth.

In some embodiments, the substrate comprises a carbon material.

In some embodiments, the carbon material is a foam, paper, aerogel, foil, fiber, one or more particles, or one or more nanostructures (e.g., rods and/or tubes).

In some embodiments, the substrate comprises a metal. In some embodiments, the metal is a foil, foam, sheet, mesh, or stock.

In some embodiments, the substrate comprises a conductive film disposed on a physical support (e.g., a non-conductive substrate). In some embodiments, the physical support is a carbon material. In some embodiments, the carbon material is a foam, paper, aerogel, foil, fiber, one or more particles, or one or more nanostructures (e.g., rods and/or tubes). In some embodiments, the physical support comprises a metal. In some embodiments, the metal is a foil, foam, sheet, mesh, or stock. In some embodiments, the physical support comprises a polymer. In some embodiments, the polymer is selected from the group consisting of polyvinylidene fluoride (PVDF), polytetrafluoroethylene (PTFE), polyvinyl alcohol, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), styrene butadiene rubber (SBR), polyaniline (PANI), polypyrrole (PPyr), polystyrene (PS), and polythiophene (PT). In some embodiments, the polymer is incorporated into the electrode in situ or ex situ.

In some embodiments, the substrate is templated.

In some aspects, the present disclosure is directed to an electrode for a battery (e.g., an aqueous secondary battery), the electrode comprising a conductive substrate and an in situ formed electroactive material deposited on the substrate (e.g., at a surface of the substrate).

In some embodiments, the electroactive material comprises one or more members selected from the group consisting of elemental (e.g., metallic) forms, oxides, suboxides, oxychlorides, oxynitrates, hydroxides, sulfides, halides, and oxide hydroxides of one or more elements, wherein the one or more elements are selected from the group consisting of titanium, vanadium, chromium, manganese, iron, aluminum, silicon, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, lead, and bismuth.

In some embodiments, the substrate comprises a carbon material. In some embodiments, the carbon material is a foam, paper, aerogel, foil, fiber, one or more particles, or one or more nanostructures (e.g., rods and/or tubes).

In some embodiments, the substrate comprises a metal. In some embodiments, the metal is a foil, foam, sheet, mesh, or stock.

In some embodiments, the substrate comprises a conductive film disposed on a physical support (e.g., a non-conductive substrate). In some embodiments, the physical support is a carbon material. In some embodiments, the carbon material is a foam, paper, aerogel, foil, fiber, one or more particles, or one or more nanostructures (e.g., rods and/or tubes). In some embodiments, the physical support comprises a metal. In some embodiments, the metal is a foil, foam, sheet, mesh, or stock. In some embodiments, the physical support comprises a polymer. In some embodiments, the polymer is selected from the group consisting of polyvinylidene fluoride (PVDF), polytetrafluoroethylene (PTFE), polyvinyl alcohol, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), styrene butadiene rubber (SBR), polyaniline (PANI), polypyrrole (Ppyr), polystyrene (PS), and polythiophene (PT). In some embodiments, the polymer is incorporated into the electrode in situ or ex situ.

In some embodiments, the substrate is templated.

The electrode may be included in an aqueous secondary battery. In some embodiments, the aqueous battery further comprises an (aqueous) electrolyte disposed in contact with the electrode. In some embodiments, the electrode is a cathode or an anode.

In some aspects, the present disclosure is directed to an electrode structure comprising: a current collector coated with a film, wherein the film is disposed to physically isolate the current collector from an electrolyte and is electron permeable (e.g., electrically conductive); and an electrode (e.g., anode or cathode) disposed on the current collector that is coated with the film.

In some embodiments, the current collector comprises a metal and a film physically isolates the metal from the electrolyte. In some embodiments, the current collector comprises an electrically conductive carbon (e.g., graphene and/or graphite).

In some embodiments, the film comprises a carbon-based material. In some embodiments, the carbon-based material is not electrically conductive. In some embodiments, the carbon-based material is electrically conductive.

In some embodiments, the film further comprises a second carbon-based material (e.g., that is electrically conductive or not electrically conductive).

In some embodiments, the carbon-based material (e.g., and the second carbon-based material) comprises a polymer comprising a repeating unit comprising a halogen.

In some embodiments, the carbon-based material comprises a polymer comprising a repeating unit comprising a ring (e.g., an aromatic ring or heterocyclic ring having 1-3 heteroatoms independently selected from nitrogen, oxygen, and sulfur).

In some embodiments, the carbon-based material is a member selected from the group consisting of polyvinylidene fluoride (PVDF), polytetrafluoroethylene (PTFE), polyvinyl alcohol, polyvinylpyrrolidone (PVP), polyvinyl acetate, polyvinyl chloride (PVC), polyaniline (PANI), polypyrrole (Ppyr), polystyrene (PS), polythiophene (PT), carboxymethyl cellulose (CMC), hydroxypropyl cellulose (HPC), hydroxyethyl cellulose (HEC), styrene butadiene rubber (SBR), carbon black, acetylene black, carbon fibers, carbon nanotubes, graphene, graphite, and fullerenes.

In some embodiments, the film is made of one or more carbon-based materials (e.g., the carbon-based material or the carbon-based material and the second carbon-based material).

In some embodiments, the film comprises one or more members selected from the group consisting of: silicon, titanium, vanadium, chromium, manganese, magnesium, lithium, sodium, potassium, iron, cobalt, nickel, copper, zinc, aluminum, gallium, a gallium oxide, zirconium, niobium, molybdenum, ruthenium, silver, cadmium, indium, tin, antimony, lanthanum, cerium, neodymium, tantalum, tungsten, rhenium, platinum, gold, lead, strontium, bismuth; halides, hydroxides, oxides, phosphates, suboxides, nitrates, nitrites, sulfates, sulfides, chlorates, bromates, iodates, and cyanides thereof; and combinations thereof (e.g., wherein the member is at least 20 wt. %, at least 40 wt. %, at least 50 wt. %, at least 60 wt. %, or at least 80 wt. % of the film). In some embodiments, each of the one or more members is a silicon oxide, a titanium oxide, a vanadium oxide, a chromium oxide, a manganese oxide, a magnesium oxide, a lithium oxide, a sodium oxide, a potassium oxide, an iron oxide, a cobalt oxide, a nickel oxide, a copper oxide, a zinc oxide, an aluminum oxide, a gallium oxide, a zirconium oxide, a niobium oxide, a molybdenum oxide, a ruthenium oxide, a silver oxide, a cadmium oxide, an indium oxide, a tin oxide, an antimony oxide, a lanthanum oxide, a cerium oxide, a tantalum oxide, a tungsten oxide, a lead oxide, a strontium oxide, or a bismuth oxide.

In some embodiments, the carbon-based material and/or the one or more members are modified (e.g., doped) with one or more members selected from the group consisting of boron, magnesium, silicon, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, lead, bismuth, and combinations thereof.

In some embodiments, one or both of the current collector and the electrode comprises (e.g., has been modified with) an ion-releasing material. In some embodiments, the ion-releasing material can release one or more ions each of one or more elements selected from the group consisting of hydrogen, lithium, boron, sodium, magnesium, silicon, potassium, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, praseodymium, neodymium, samarium, europium, gadolinium, terbium, dysprosium, holmium, erbium, thulium, ytterbium, lutetium, tantalum, tungsten, rhenium, platinum, gold, lead, bismuth, actinium, thorium, protactinium, and uranium. In some embodiments, the ion-releasing material is a metal, a silicate, an aluminum silicate, or a silicon aluminum phosphate. In some embodiments, the ion-releasing material is disposed on a surface of the one or more of current collector or electrode or in bulk of the electrode.

In some embodiments, a surface of the current collector has been chemically or electrochemically modified. In some embodiments, the surface has been modified with one or more members selected from the group consisting of: silicon, a silicon oxide, titanium, a titanium oxide, vanadium, a vanadium oxide, chromium, a chromium oxide, manganese, a manganese oxide, magnesium, a magnesium oxide, lithium, a lithium oxide, sodium, a sodium oxide, potassium, a potassium oxide, iron, an iron oxide, cobalt, a cobalt oxide, nickel, a nickel oxide, copper, a copper oxide, zinc, a zinc oxide, aluminum, an aluminum oxide, gallium, a gallium oxide, zirconium, a zirconium oxide, niobium, a niobium oxide, molybdenum, a molybdenum oxide, ruthenium, a ruthenium oxide, silver, a silver oxide, cadmium, a cadmium oxide, indium, an indium oxide, tin, a tin oxide, antimony, an antimony oxide, lanthanum, a lanthanum oxide, cerium, a cerium oxide, neodymium, tantalum, a tantalum oxide, tungsten, a tungsten oxide, rhenium, platinum, gold, lead, a lead oxide, strontium, a strontium oxide, bismuth, and a bismuth oxide; halides, hydroxides, oxides, phosphates, suboxides, nitrates, nitrites, sulfates, sulfides, chlorates, bromates, iodates, and cyanides thereof; and combinations thereof.

In some embodiments, surface of the current collector comprises an organometallic complex that comprises one or more of (i) a metal or metal oxide and (ii) one or more anions. In some embodiments, the one or more anions are selected from the group consisting of carbonates, sulfates, sulfites, nitrates, nitrites, phosphates, phosphites, chromates, halides, amines, azides, acrylates, methacrylates, hydroxides, and combinations thereof.

In some embodiments, a surface of the current collector is modified with both one or more non-aluminum metals and one or more anions capable of forming an organometallic complex.

In some embodiments, a surface of the electrode (e.g., of the current collector) comprises a polymer coating. In some embodiments, the polymer coating is a coating of a polymer selected from the group consisting of polyaniline (PANI), polypyrrole (Ppyr), and polythiophene (PT).

The electrode structure may be included in an aqueous secondary battery.

In some aspects, the present disclosure is directed to an electrode (e.g., anode or cathode) structure, comprising a substrate and an ion-releasing material. In some embodiments, the substrate is a current collector. In some embodiments, the ion-releasing material is a metal, a silicate, an aluminum silicate, or a silicon aluminum phosphate. In some embodiments, the ion-releasing material is disposed on a surface of the electrode (e.g., a surface of the substrate) or in bulk of the electrode (e.g., bulk of the substrate). In some embodiments, the ion-releasing material can release one or more ions each of one or more elements selected from the group consisting of hydrogen, lithium, boron, sodium, magnesium, silicon, potassium calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, praseodymium, neodymium, samarium, europium, gadolinium, terbium, dysprosium, holmium, erbium, thulium, ytterbium, lutetium, tantalum, tungsten, rhenium, platinum, gold, lead, bismuth, actinium, thorium, protactinium, and uranium. In some embodiments, the substrate (e.g., the current collector) is in contact with a galvanic corrosion reducing material (e.g., wherein the galvanic corrosion reducing material is disposed on a surface of the electrode or in a bulk of the electrode). In some embodiments, the material comprises a carbon-based material (e.g., selected from the group consisting of carbon black, acetylene black, carbon fibers, carbon nanotubes, graphene, graphite, and fullerenes). In some embodiments, the material comprises a metal, an alloy, an oxide, a suboxide, a sulfide, a hydroxide, an oxide hydroxide, an oxychloride, an oxynitrate, a carbonate, a nitride, or a carbide of one or more elements selected from the group consisting of magnesium, silicon, calcium, titanium, vanadium, chromium, manganese, iron, cobalt, nickel, copper, zinc, gallium, zirconium, niobium, molybdenum, ruthenium, silver, cadmium, indium, tin, antimony, lanthanum, cerium, neodymium, tantalum, tungsten, rhenium, platinum, gold, lead, and bismuth. The electrode structure may be included in an aqueous secondary battery, wherein the battery is operable to release ions from the ion-releasing material thereby depositing material to mitigate electrochemical passivation and/or one or more side reactions.

In some aspects, the present disclosure is directed to an electrode (e.g., anode or cathode) structure, comprising a substrate (e.g., current collector) coated with a film, wherein the film physically isolates the substrate from the electrolyte and is electron permeable (e.g., electrically conductive).

In some aspects, the present disclosure is directed to an aluminum metal based anode, comprising aluminum metal coated with a film, wherein the film is disposed to physically isolate the aluminum metal from an electrolyte and is electron permeable (e.g., electrically conductive).

In some embodiments, the film comprises a carbon-based material. In some embodiments, the carbon-based material is not electrically conductive. In some embodiments, the carbon-based material is electrically conductive. In some embodiments, the film further comprises a second carbon-based material (e.g., that is electrically conductive or not electrically conductive). In some embodiments, the carbon-based material (e.g., and the second carbon-based material) comprises a polymer comprising a repeating unit comprising a halogen. In some embodiments, the carbon-based material comprises a polymer comprising a repeating unit comprising a ring (e.g., an aromatic ring or heterocyclic ring having 1-3 heteroatoms independently selected from nitrogen, oxygen, and sulfur).

In some embodiments, the carbon-based material is a member selected from the group consisting of polyvinylidene fluoride (PVDF), polytetrafluoroethylene (PTFE), polyvinyl alcohol, polyvinylpyrrolidone (PVP), polyvinyl acetate, polyvinyl chloride (PVC), polyaniline (PANI), polypyrrole (Ppyr), polystyrene (PS), polythiophene (PT), carboxymethyl cellulose (CMC), hydroxypropyl cellulose (HPC), hydroxyethyl cellulose (HEC), styrene butadiene rubber (SBR), carbon black, acetylene black, carbon fibers, carbon nanotubes, graphene, graphite, and fullerenes.

In some embodiments, the film is made of one or more carbon-based materials (e.g., the carbon-based material or the carbon-based material and the second carbon-based material).

In some embodiments, the film comprises one or more members selected from the group consisting of: silicon, titanium, vanadium, chromium, manganese, magnesium, lithium, sodium, potassium, iron, cobalt, nickel, copper, zinc, aluminum, gallium, a gallium oxide, zirconium, niobium, molybdenum, ruthenium, silver, cadmium, indium, tin, antimony, lanthanum, cerium, neodymium, tantalum, tungsten, rhenium, platinum, gold, lead, strontium, bismuth, mercury; halides, hydroxides, oxides, phosphates, suboxides, nitrates, nitrites, sulfates, sulfides, chlorates, bromates, iodates, and cyanides thereof; and combinations thereof (e.g., wherein the member is at least 20 wt. %, at least 40 wt. %, at least 50 wt. %, at least 60 wt. %, or at least 80 wt. % of the film). In some embodiments, each of the one or more members is a silicon oxide, a titanium oxide, a vanadium oxide, a chromium oxide, a manganese oxide, a magnesium oxide, a lithium oxide, a sodium oxide, a potassium oxide, an iron oxide, a cobalt oxide, a nickel oxide, a copper oxide, a zinc oxide, an aluminum oxide, a gallium oxide, a zirconium oxide, a niobium oxide, a molybdenum oxide, a ruthenium oxide, a silver oxide, a cadmium oxide, an indium oxide, a tin oxide, an antimony oxide, a lanthanum oxide, a cerium oxide, a tantalum oxide, a tungsten oxide, a lead oxide, a strontium oxide, or a bismuth oxide.

In some embodiments, the carbon-based material and/or the one or more members are modified (e.g., doped) with one or more members selected from the group consisting of boron, magnesium, silicon, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, lead, bismuth, and combinations thereof.

In some aspects, the present disclosure is directed to an aluminum metal anode [e.g., in an aqueous (e.g., aluminum-ion) secondary battery], comprising aluminum metal and an ion-releasing material (e.g., wherein the aluminum metal has been modified with the ion-releasing material).

In some embodiments, the ion-releasing material can release one or more ions each of one or more elements selected from the group consisting of hydrogen, lithium, boron, sodium, magnesium, silicon, potassium calcium, vanadium, manganese, iron, cobalt, nickel, copper, zinc, gallium, strontium, zirconium, molybdenum, ruthenium, silver, cadmium, indium, tin, antimony, lanthanum, cerium, tantalum, tungsten, rhenium, and bismuth.

In some embodiments, ion-releasing material is a metal, a silicate, an aluminum silicate, or a silicon aluminum phosphate

In some embodiments, the ion-releasing material is disposed on a surface of the anode (e.g., a surface of the current collector) or in bulk of the anode (e.g., bulk of the current collector).

In some embodiments, a surface of the anode has been chemically or electrochemically modified. In some embodiments, the surface has been modified with one or more members selected from the group consisting of: silicon, a silicon oxide, titanium, a titanium oxide, vanadium, a vanadium oxide, manganese, a manganese oxide, magnesium, a magnesium oxide, iron, an iron oxide, cobalt, a cobalt oxide, nickel, copper, zinc, a zinc oxide, aluminum, an aluminum oxide, gallium, a gallium oxide, zirconium, a zirconium oxide, niobium, a niobium oxide, molybdenum, a molybdenum oxide, ruthenium, a ruthenium oxide, silver, a silver oxide, tin, a tin oxide, antimony, an antimony oxide, tantalum, a tantalum oxide, tungsten, a tungsten oxide, rhenium, strontium, a strontium oxide, bismuth, and a bismuth oxide; halides, hydroxides, oxides, phosphates, suboxides, nitrates, nitrites, sulfates, sulfides, chlorates, bromates, iodates, and cyanides thereof; and combinations thereof.

In some embodiments, a surface of the anode comprises an organometallic complex that comprises one or more of (i) a metal or metal oxide and (ii) one or more anions. In some embodiments, the one or more anions are selected from the group consisting of carbonates, sulfates, sulfites, nitrates, nitrites, phosphates, phosphites, chromates, halides, amines, azides, acrylates, methacrylates, hydroxides, and combinations thereof.

In some embodiments, a surface of the anode is modified with both one or more non-aluminum metals and one or more anions capable of forming an organometallic complex.

In some embodiments, a surface of the anode (e.g., of the current collector) comprises a polymer coating. In some embodiments, the polymer coating is a coating of a polymer selected from the group consisting of polyaniline (PANI), polypyrrole (Ppyr), and polythiophene (PT).

In some embodiments, the aluminum metal is in contact with a galvanic corrosion reducing material (e.g., wherein the galvanic corrosion reducing material is disposed on a surface of the anode or in a bulk of the anode). In some embodiments, the material comprises a carbon-based material (e.g., selected from the group consisting of carbon black, acetylene black, carbon fibers, carbon nanotubes, graphene, graphite, and fullerenes). In some embodiments, the material comprises a metal, an alloy, an oxide, a suboxide, a sulfide, a hydroxide, an oxide hydroxide, an oxychloride, an oxynitrate, a carbonate, a nitride, or a carbide of one or more elements selected from the group consisting of magnesium, silicon, calcium, titanium, vanadium, chromium, manganese, iron, cobalt, nickel, copper, zinc, gallium, zirconium, niobium, molybdenum, ruthenium, silver, cadmium, indium, tin, antimony, lanthanum, cerium, neodymium, tantalum, tungsten, rhenium, platinum, gold, lead, and bismuth.

The anode may be included in an aqueous secondary battery.

Any two or more of the features described in this specification, including in this summary section, may be combined to form implementations not specifically explicitly described in this specification.

### BRIEF DESCRIPTION OF THE DRAWING

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIG. 1 shows a current density-voltage plot for a cerium oxide-based transition metal oxide electrode compared to a reference electrode during electrochemical cycling, according to illustrative embodiments of the present disclosure;

FIG. 2 shows current density-voltage plot for a bismuth vanadate-based mixed metal oxide electrode compared to a reference electrode during electrochemical cycling, according to illustrative embodiments of the present disclosure;

FIG. 3 shows a current density-voltage plot for a manganese tungstate-based mixed metal oxide electrode compared to a reference electrode during electrochemical cycling, according to illustrative embodiments of the present disclosure;

FIG. 4 shows a voltage-capacity plot of a manganese tungstate-based mixed metal oxide electrode compared to a manganese oxide electrode, according to illustrative embodiments of the present disclosure;

FIG. 5 shows a current-voltage plot of a manganese tungstate-based mixed metal oxide electrode, according to illustrative embodiments of the present disclosure;

FIG. 6 and FIG. 7 show in operando X-ray diffraction plots of a tungsten-based metal oxide anode, according to illustrative embodiments of the present disclosure;

FIG. 8 shows an in operando X-ray diffraction plot during self-discharge of a tungsten-based metal oxide anode, according to illustrative embodiments of the present disclosure; and

FIG. 9 shows self-discharge plots of a tungsten-based metal oxide anode, according to illustrative embodiments of the present disclosure.

### DETAILED DESCRIPTION OF CERTAIN EMBODIMENTS

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included.

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art. Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps. It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In other embodiments, a first layer on a second layer can include another layer there between. Headers are provided for the convenience of the reader and are not intended to be limiting with respect to the claimed subject matter.

Described herein are, inter alia, electrodes for use in energy storage devices, such as a cathode or anode in a battery. An electrode may include a substrate (e.g., a conductive substrate) which serves as a reaction site, for example for redox reactions, that occur during electrochemical cycling of an energy storage device. In some embodiments, an electrode can undergo intercalation chemistry, conversion chemistry, plating-stripping/deposition-dissolution chemistry, or combinations thereof. For example, material (e.g., one or more species) may plate and strip or deposit and dissolve during electrochemical cycling of an energy storage device. A film (e.g., coating) and/or additive may be provided in an electrode in order to mitigate side reactions and/or electrochemical passivation reactions. An electrode may include one or more materials that (i) electrochemically reduce a portion of the electrolyte to a gas during electrochemical cycling, (ii) suppress generation of hydrogen gas by increasing a hydrogen evolution overpotential, (iii) constrain gas after formation, and/or (iv) catalyze oxidation of a gas back into an electrolyte. An electrode may include one or more electroactive materials in addition to a substrate (e.g., current collector) or not.

An energy storage device may include an electrode as disclosed herein. The energy storage device may be, for example, a battery, a fuel cell, or a capacitor. The battery may be a primary battery or a secondary battery. In some embodiments, the battery is a secondary battery. Independently of whether it is primary or secondary, the battery may be an aqueous battery or a non-aqueous battery (e.g., that includes a solid-state electrolyte). In some embodiments, an energy storage device that includes an electrode as disclosed herein is a secondary aqueous battery. The battery may be an ion battery, such as an aluminum-ion or lithium-ion battery, or an air battery, for example. The energy storage device need not have a specific cell construction, cathode composition, anode composition, electrolyte composition, or composition of any other (counter) electrode.

### Conductive Substrate Electrodes Participating in or Supporting Electrochemical Reactions in an Aqueous Electrolyte for Energy Storage Systems

Provided herein are electrodes that can be used in electrochemical cells, such as aqueous secondary batteries. An electrochemical cell may include an anode, a cathode, a separator that prevents direct physical contact of the anode and the cathode, and an electrolyte. An electrochemical cell may be a battery, that has any one or more of a variety of form factors. For example, the electrochemical cell may be a pouch cell, a coin cell, a cylindrical cell, or a prismatic cell. The electrode may have a structure that improves (e.g., optimizes) electrochemical kinetics in an aqueous (e.g., secondary) battery.

One or both of an anode and a cathode may include one or more materials selected from the following: halides, hydroxides, oxides, phosphates, suboxides, nitrates, nitrites, sulfates, sulfides, chlorates, bromates, iodates, or elemental forms of a metal. The metal may be silicon, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, neodymium, tantalum, tungsten, rhenium, platinum, gold, lead, strontium, bismuth, mercury, or a combination thereof. For example, an anode or a cathode or both may include (e.g., be made of) a metal, such as silicon, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, neodymium, tantalum, tungsten, rhenium, platinum, gold, lead, strontium, bismuth, mercury, or a combination (e.g., alloy) thereof. As another example, an anode or a cathode or both may include a metal oxide, such as a silicon oxide, a titanium oxide, a vanadium oxide, a chromium oxide, a manganese oxide, a magnesium oxide, a lithium oxide, a sodium oxide, a potassium oxide, an iron oxide, a cobalt oxide, a nickel oxide, a copper oxide, a zinc oxide, an aluminum oxide, a gallium oxide, a zirconium oxide, a niobium oxide, a molybdenum oxide, a ruthenium oxide, a silver oxide, a cadmium oxide, an indium oxide, a tin oxide, an antimony oxide, a lanthanum oxide, a cerium oxide, a tantalum oxide, a tungsten oxide, a lead oxide, a strontium oxide, or a bismuth oxide, or a ternary or quaternary oxide comprising one or more of silicon, calcium, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, tantalum, tungsten, lead, strontium, and bismuth.

One or more materials of an anode, a cathode, or both may further include one or more additives, one or more dopants, one or more interstitial alloys, or one or more interstitial compounds, one or more chemical bonds, or one or more physical bonds (such as weak van der Waal's forces) with one or more elements. Suitable elements include hydrogen, boron, carbon, nitrogen, sodium, potassium, lithium, calcium, sulfur, phosphorus, manganese, magnesium, iron, cobalt, nickel, copper, zinc, aluminum, gallium, zirconium, niobium, molybdenum, ruthenium, cadmium, indium, tin, antimony, lanthanum, cerium, neodymium, tantalum, tungsten, rhenium, platinum, lead, strontium, bismuth, halides, and combinations thereof. One or more materials of an anode, a cathode, or both may further comprise defects, vacancies, moieties, holes (e.g., pores), or other structural modifications. The one or more materials may be treated to introduce (e.g., incorporate) the defects, vacancies, moieties, holes (e.g., pores), or other structural modifications. The one or more materials may further include water molecules and/or one or more anions and/or one or more functional groups with or without a physical or chemical bonding. The one or more anions may include one or more of, or a combination of: a phosphate, a sulfate, a sulfide, a nitrate, a nitride, a halide, a hydride, a hydrate, a hydroxide, an oxide, an alkane, an alkene, an alkyne, a phenyl, a phenol, an amine, an amide, an ether, an alkyl halide, a thiol, an aldehyde, an ester, a carboxylic acid, an ester, and an alcohol.

In some embodiments, one or both electrodes (e.g., an anode and/or cathode) may exist in the form of an alloy, a mixed metal oxide, or composite wherein the alloy, the mixed metal oxide, or the composite is formed with one or more of carbon, a carbide, silicon, a silicon oxide, titanium, a titanium oxide, vanadium, a vanadium oxide, chromium, a chromium oxide, manganese, a manganese oxide, magnesium, a magnesium oxide, lithium, a lithium oxide, sodium, a sodium oxide, potassium, a potassium oxide, iron, an iron oxide, cobalt, a cobalt oxide, nickel, a nickel oxide, copper, a copper oxide, zinc, a zinc oxide, aluminum, an aluminum oxide, gallium, a gallium oxide, zirconium, a zirconium oxide, niobium, a niobium oxide, molybdenum, a molybdenum oxide, ruthenium, a ruthenium oxide, silver, a silver oxide, cadmium, a cadmium oxide, indium, an indium oxide, tin, a tin oxide, antimony, an antimony oxide, lanthanum, a lanthanum oxide, cerium, a cerium oxide, neodymium, tantalum, a tantalum oxide, tungsten, a tungsten oxide, rhenium, platinum, gold, lead, a lead oxide, strontium, strontium oxide, bismuth, and a bismuth oxide.

In some embodiments, an electrode (e.g., anode or cathode, or both) may comprise particles. For example, an electrode primary particles or secondary particles that include primary particles. In some embodiments, the particles may comprise multiple different materials to form a composite. In some embodiments, at least one material may be partially or fully encapsulated by at least one other material [e.g., particles disposed (e.g., dispersed) in a matrix]. In some embodiments, materials may be combined such that the materials form a solid mixture. In some embodiments, particles comprising a solid mixture may be partially or fully encapsulated by one or more materials [e.g., particles of a solid mixture of materials disposed (e.g., dispersed) in a matrix of the one or more materials].

In some embodiments, one or both electrodes of an energy storage device are crystalline, amorphous, polycrystalline, polymorphous, or a combination thereof or include(s) one or more materials that are crystalline, amorphous, polycrystalline, polymorphous, or a combination thereof.

In some embodiments, electrodes in an energy storage device are used in conjunction with one or more separators. A suitable separator may comprise one or more of, or a combination of: polyethylene, polypropylene, polyethersulfone, sodium, lithium, potassium calcium, magnesium, aluminum, an aluminum oxide, a tin oxide, a titanium oxide, a silicon oxide, a silicon carbide, a silicon nitride, a silicon aluminum oxynitride, a zinc oxide, ferrites, cerium, a cerium oxide, hydrogen, water molecules, lanthanum, a lanthanum oxide, boron, a boron oxide, a boron nitride, zirconium, and a zirconium oxide. The separator may exist in the form of a free-standing film, with or without a polymer reinforcement (e.g., as a structural support), or the separator may be deposited directly on to one or both the electrodes (e.g., as a coating or as a gel or gel-like layer) (e.g., deposited ex situ or in situ). The deposition method may include, for example, one or more of physical vapor deposition techniques (e.g., sputtering, e-beam evaporation, thermal evaporation, atomic layer deposition), chemical vapor deposition, spray-coating, casting, drop casting, doctor-blade coating, and slot-die coating. The separator material may also include additives such as polymer binders to aid in the deposition process and/or structural integrity of the separator. Suitable binders may include but are not limited to polyvinylidene fluoride (PVDF), polytetrafluoroethylene (PTFE), polyvinyl alcohol, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), styrene butadiene rubber (SBR), and nafion. The separator may contain impurities that are generally associated with chemical synthesis or other manufacturing techniques. These impurities may include, for example, carbon, hydrogen, water, halides, iron, nickel, chromium, tin, aluminum, or silicon, or oxides, carbides, nitrates, sulfates, or phosphates of iron, nickel, chromium, tin, aluminum, or silicon, or a combination thereof.

In some embodiments, a separator is intimately connected to one or both electrodes through one or more of direct deposition on the electrode(s) and calendaring. In some embodiments, the intimate connection allows for one or more of improved ionic conductivity, improved insulation, and better wettability.

In some embodiments, a separator can take up and release one or more ions during a charge or discharge process (e.g., take up during one and release during the other), allowing for an improved ion diffusion kinetic. Ions that may be taken up and released by such a separator may be, for example, ions of titanium, vanadium, chromium, manganese, magnesium, lithium, sodium, potassium, iron, cobalt, nickel, copper, zinc, gallium, hydrogen, zirconium, niobium, molybdenum, ruthenium, silver, cadmium, indium, tin, antimony, lanthanum, cerium, neodymium, tantalum, tungsten, strontium, bismuth, or a hydroxide, an oxide-hydroxide, a nitrate, a sulfate, a phosphate, or a halide, or a combination thereof. For example, a nonconductive metal oxide complex in a separator may be capable of undergoing ion exchange during electrochemical cycling and an electrolyte may then change composition [e.g., a metal oxide complex containing Na+ that exchanges the Na+ for H+ as during cycling (e.g., during which pH of the electrolyte decreases)].

In some embodiments, a separator promotes or inhibits reversible or irreversible dissolution of one or more metals, one or more metal oxides, or both. The one or more metals may include, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, neodymium, tantalum, tungsten, rhenium, strontium, bismuth, neodymium, or a combination thereof. The one or more metal oxides may include a silicon oxide, a titanium oxide, a vanadium oxide, a chromium oxide, a manganese oxide, a magnesium oxide, a lithium oxide, a sodium oxide, a potassium oxide, an iron oxide, a cobalt oxide, a nickel oxide, a copper oxide, a zinc oxide, an aluminum oxide, a gallium oxide, a zirconium oxide, a niobium oxide, a molybdenum oxide, a ruthenium oxide, a silver oxide, a cadmium oxide, an indium oxide, a tin oxide, an antimony oxide, a lanthanum oxide, a cerium oxide, a tantalum oxide, a tungsten oxide, a strontium oxide, a bismuth oxide, a neodymium oxide, or a combination thereof.

In some embodiments, one or more electrodes and one or more separators may be used in an alkaline environment, wherein the pH of the electrolyte is higher than 8, preferably higher than 10. In some embodiments, one or more electrodes and one or more separators may be used in a neutral environment, wherein the pH of the electrolyte is at least 6 and no higher than 8. In some embodiments, one or more electrodes and one or more separators may be used in an acidic electrolyte, wherein the acidity of the electrolyte is less than 6, preferably less than 4. In some embodiments, an electrochemical cell uses a combination of environments, wherein one of two electrodes is in an alkaline environment and the other electrode is in an acidic environment, or wherein one of two electrodes is in an alkaline environment and the other electrode is in a neutral environment, or wherein one of two electrodes is in an acidic environment and the electrode is in a neutral environment. In some embodiments, one of two electrodes is in a relatively less acidic environment at a stage of charge and the other of the two electrodes is in a relatively more acidic environment at the stage of charge. The relatively less acidic environment may be a neutral environment (e.g., having a pH of at least 6 and no higher than 8) or an alkaline environment (e.g., having a pH of higher than 8 or higher than 10). The relatively more acidic environment may be a neutral environment (e.g., having a pH of at least 6 and no higher than 8) or an acidic environment (e.g., having a pH of less than 6 or less than 4).

In some embodiments, one or both electrodes in an energy storage system undergoes an ion exchange with an electrolyte during electrochemical cycling. Two electrodes may exchange (e.g., only) one or more same types of ions with the electrolyte as each other during the electrochemical cycling, such as, for example, aluminum ions, sulfur ions, hydrogen ions, or a combination thereof. For example, both electrodes may separately exchange only one type of ion or only exchange two types of ion (e.g., of two different elements). Two electrodes may exchange (e.g., only) one or more different types of ions with an electrolyte from each other during the electrochemical cycling, such as, for example, aluminum ions, sulfur ions, or hydrogen ions. For example, a first electrode (e.g., anode or cathode) may exchange a first type of ion with an electrolyte while a second electrode (e.g., cathode or anode, respectively) may exchange a different second type of ion with the electrolyte. In some embodiments, two electrodes exchange with an electrolyte at least one same type of ion as each other and at least one different type of ion from each other. In various of these embodiments, ions do not travel from one of the two electrodes to the other of the two electrodes during electrochemical cycling though they are exchanged, separately, with one or both of the electrodes.

In some embodiments, an electrolyte of an energy storage device (e.g., electrochemical cell, e.g., battery) comprises one or more additives to achieve one or more of the following: (1) promote hydrogen evolution reaction, (2) impede hydrogen evolution reaction, (3) promote oxygen evolution reaction, (4) impede oxygen evolution reaction, (5) promote dissolution species from one or both the electrodes, (6) impede dissolution species from one or both the electrodes, (7) promote stripping and plating of metal ions, (8) impede stripping and plating of metal ions, (9) promote conversion between metals and metal oxides, and (10) impede conversion between metals and metal oxides.

In some embodiments, an electrolyte of an energy storage device (e.g., electrochemical cell, e.g., battery) includes one or more ions, for example ions of one or more of hydrogen, hydroxide, sodium, potassium, lithium, calcium, sulfur, manganese, magnesium, iron, cobalt, nickel, copper, zinc, aluminum, gallium, zirconium, niobium, molybdenum, ruthenium, cadmium, indium, tin, antimony, lanthanum, cerium, neodymium, tantalum, tungsten, rhenium, strontium, or bismuth, or a halide, a nitrate, an acetate, a borate, a carboxylate, a nitride, a sulfate, a sulfide, a carbonate, a phosphate, a phosphide, an oxide, or an oxide-hydroxide, or a combination thereof. In some embodiments, one or more of the ions present in an electrolyte may be surrounded by solvation shells. In some embodiments, one or more ions that may or may not comprise solvation shells may promote ion diffusion into one or both the electrodes, wherein the ion being diffused into the electrode structure is an electroactive species. In some embodiments, an electrolyte includes a weak acid. An ion that is an electroactive species is as an ion that directly contributes to electron contribution in an energy storage device (e.g., electrochemical cell, e.g., battery) or plays a role in stabilizing the energy storage device (e.g., electrolyte and/or one or more electrodes) (for example, stabilization of crystal structure, phase retention, and/or reversible phase transformation).

### Aqueous Battery Electrodes

Provided herein are electrodes that can be used in electrochemical cells, such as aqueous secondary batteries. An electrochemical cell may include an anode, a cathode, a separator that prevents direct physical contact of the anode and the cathode, and an electrolyte. An electrochemical cell may be a battery, that has any one or more of a variety of form factors. For example, the electrochemical cell may be a pouch cell, a coin cell, a cylindrical cell, or a prismatic cell.

In some embodiments, an electrode (e.g., anode or cathode) of an energy storage device comprises one or more materials structured to accommodate reversible storage of (e.g., intercalation of) one or more monatomic, monovalent cations, one or more monatomic, multivalent cations, one or more polyatomic monovalent anions, one or more polyatomic, multivalent anions, or a combination thereof. A monoatomic, monovalent cation reversibly stored by such one or more materials may be, for example, a cation of hydrogen, lithium, sodium, potassium, rubidium, or cesium. A monatomic, multivalent cation reversibly stored by such one or more materials may be, for example, a cation of magnesium, aluminum, calcium, titanium, vanadium, chromium, manganese, iron, cobalt, nickel, copper, zinc, gallium, zirconium, niobium, molybdenum, ruthenium, silver, cadmium, indium, tin, antimony, lanthanum, cerium, neodymium, tantalum, tungsten, or bismuth. A polyatomic monovalent or multivalent anion reversibly stored by such one or more materials may be, for example, a halide, a hydroxide, an oxide, a phosphate, a suboxide, a nitrate, a nitrite, a sulfate, a sulfide, a chlorate, a bromate, an iodate, or some combination of any of the aforementioned ions. This electrode material may include, for example, a metal, an oxide, halides, a suboxide, hydroxide, oxide hydroxide, oxychloride, oxynitrate, sulfide, oxysulfide, carbonate, nitrate, nitride, carbide, phosphate, polymer, or combination thereof containing hydrogen, lithium, carbon, nitrogen, oxygen, sulfur, sodium, magnesium, aluminum, silicon, potassium, calcium, titanium, vanadium, chromium, manganese, iron, cobalt, nickel, copper, zinc, gallium, zirconium, niobium, molybdenum, ruthenium, silver, cadmium, indium, tin, antimony, lanthanum, cerium, neodymium, tantalum, tungsten, rhenium, bismuth, or some combination thereof. The electrode material may reversibly store (e.g., adsorb or intercalate) ions primarily near the surface or may reversibly store (e.g., adsorb or intercalate) ions throughout bulk of the material. The electrode material may be freestanding or may be present on a substrate. The substrate may include, for example, one or more carbon materials such as foams, papers, aerogels, foils, fibers, particles, or nanostructures (e.g., tubes and/or rods), or metal foils, foams, sheets, meshes, or stock.

The one or more or a combination of the electrode materials described above could undergo an intercalation described generally in an example as the following:

MY+A⁺ⁿ+ne [symbol] MAY, wherein M is a metal, Y can be any of metal, oxide, a suboxide, hydroxide, oxide hydroxide, oxychloride, oxynitrate, sulfide, oxysulfide, carbonate, nitrate, nitride, carbide, phosphate, polymer, or combinations thereof, and A is an intercalating ion, as described in the list above.

Another example could be described by,

MY+A⁺ⁿ+ne+B^{+m}+me [symbol] MABY, wherein M is a metal, Y can be any of metal, oxide, a suboxide, hydroxide, oxide hydroxide, oxychloride, oxynitrate, sulfide, oxysulfide, carbonate, nitrate, nitride, carbide, phosphate, polymer, or combination thereof, and A, B are intercalating ions, as described in the list above.

In some embodiments, the one or more or a combination of the electrode materials described above could undergo a conversion chemistry described generally in an example as the following:

M^{[n]}Y₂+zX⁺+[n−m]e [symbol] M^{[m]}Y+YX_{z}, wherein M is a metal, Y can be any of metal, oxide, a suboxide, hydroxide, oxide hydroxide, oxychloride, oxynitrate, sulfide, oxysulfide, carbonate, nitrate, nitride, carbide, phosphate, polymer, or combination thereof, X is a monovalent or multivalent species that can react or otherwise combine with Y, and n and m are transition states of M.

In some embodiments, one or more of the electrode materials described above could undergo a plating-stripping or deposition-dissolution reaction mechanism.

During charge, cations including one or more of magnesium, calcium, titanium, vanadium, chromium, manganese, magnesium, lithium, sodium, potassium, iron, cobalt, nickel, copper, zinc, gallium, zirconium, niobium, molybdenum, ruthenium, silver, cadmium, indium, tin, antimony, niobium, tantalum, tungsten, rhenium, bismuth, or some combination thereof may reduce on a conductive substrate to form a metal layer. In some embodiments, on discharge, the materials deposited on a substrate may oxidize and convert to a cationic form. In some embodiments, on discharge, one or more materials deposited on the substrate may oxidize and dissolve into an electrolyte. In some embodiments, multiple materials may deposit (e.g., and dissolve) on a substrate during cycling.

One or more or a combination of the electrode materials described above could undergo an plating-stripping reaction described generally in an example as the following:

M⁺ⁿ+ne [symbol] M, wherein M is a metal

In some embodiments, an electrode can undergo intercalation chemistry, conversion chemistry, plating-stripping/deposition-dissolution chemistry, or combinations thereof.

In some embodiments, an energy storage device is a battery comprising an aqueous electrolyte. The electrolyte may contain cations of any one or more of the aforementioned metals. In addition, the electrolyte may contain one or more anions. Suitable anions include nitrates, sulfates, phosphates, oxides, suboxides, hydroxides, oxide-hydroxides, triflates, sulfonimides, oxalatoborates, acetates, halides, and combinations thereof. The pH of the electrolyte is unrestricted. In some embodiments, additives including citric acid, malic acid, tartaric acid, gluconic acid, glucaric acid, acetic acid, glycine, phosphates, pyrophosphates may also be incorporated to facilitate a plating and stripping process, to enhance solubility of some components, or to change the rate of one or more of hydrogen evolution, oxygen evolution, NOₓ evolution, and SOₓ evolution in the battery.

In some embodiments, and not bounded by a particular mechanism, an electrode (e.g., anode or cathode) comprises one or more of silicon, a silicon oxide, titanium, a titanium oxide, vanadium, a vanadium oxide, chromium, a chromium oxide, manganese, a manganese oxide, magnesium, a magnesium oxide, lithium, a lithium oxide, sodium, a sodium oxide, potassium, a potassium oxide, iron, an iron oxide, cobalt, a cobalt oxide, nickel, a nickel oxide, copper, a copper oxide, zinc, a zinc oxide, aluminum, an aluminum oxide, gallium, a gallium oxide, zirconium, a zirconium oxide, niobium, a niobium oxide, molybdenum, a molybdenum oxide, ruthenium, a ruthenium oxide, silver, a silver oxide, cadmium, a cadmium oxide, indium, an indium oxide, tin, a tin oxide, antimony, an antimony oxide, tantalum, a tantalum oxide, tungsten, a tungsten oxide, rhenium, strontium, a strontium oxide, bismuth, and a bismuth oxide, or halides, hydroxides, oxides, phosphates, suboxides, nitrates, nitrites, sulfates, sulfides, chlorates, bromates, iodates, or cyanides thereof, or combinations thereof. The material may be freestanding or may be present on a substrate. The substrate may include, for example, one or more carbon materials such as a foams, a paper, an aerogel, a foil, a fiber, or nanostructures, or metal foils, foams, sheets, meshes, or stock.

In some embodiments, an electrode includes a material to suppress generation of hydrogen gas by increasing a hydrogen evolution overpotential. This material may be applied to a surface of the electrode, behind the electrode, as one or more layers in a multilayer electrode, or throughout bulk of the electrode. The material may include, for example, a metal, an oxide, a suboxide, a hydroxide, a peroxide, an oxide hydroxide, an oxychloride, an oxynitrate, a carbonate, a nitride, a carbide, a polymer, or a combination thereof of one or more members selected from the group consisting of hydrogen, lithium, boron, carbon, nitrogen, oxygen, lignin, sulfur, sodium, magnesium, aluminum, silicon, potassium, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, manganese, lanthanum, cerium, neodymium, tantalum, tungsten, rhenium, lead, bismuth, and combinations thereof. For example, this material may be or include an elemental form of (e.g., metallic form of) or oxide of bismuth, zinc, indium, mercury, lead, or tin.

In some embodiments, an electrode is comprised of a material capable of electrochemically reducing components of the electrolyte to a gas during cycling. This material may be applied to a surface of the electrode, behind the electrode, as one or more layers in a multilayer electrode, or throughout bulk of the electrode. The material may react irreversibly, may react reversibly, or may act as a catalyst to generate gas. For example, the material may be or include a water splitting catalyst, such as, for example, platinum or nickel. The material may include, for example, a metal, an oxide, a suboxide, a hydroxide, an oxide hydroxide, an oxychloride, an oxynitrate, a carbonate, a nitride, a carbide, a polymer, or a combination thereof of one or more members selected from the group consisting of hydrogen, lithium, boron, carbon, nitrogen, oxygen, sulfur, sodium, magnesium, aluminum, silicon, potassium, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, antimony, manganese, lanthanum, cerium, neodymium, tantalum, tungsten, rhenium, platinum, gold, and combinations thereof.

In some embodiments, an electrode may constrain gas after formation. The electrode may contain a high surface area material capable of trapping the gas after generation. This material may be applied to a surface of the electrode, behind the electrode, as one or more layers in a multilayer electrode, or throughout bulk of the electrode. This material may include carbon, such as activated carbon, carbon black, acetylene black, or carbon nanotubes; silicon containing materials, such as tectosilicates, fumed silica, or silicon dioxide; aluminates; silicates; metal organic frameworks; metal oxides; or combinations thereof. These materials may be further modified to act as catalysts for electrolyte reduction and/or oxidation. These materials may be modified with elements including, but not limited to, hydrogen, lithium, boron, carbon, nitrogen, oxygen, sulfur, sodium, magnesium, aluminum, silicon, potassium, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, lead, bismuth, or some combination thereof.

In some embodiments, an electrode may contain a material capable of catalyzing oxidation of a gas back into an electrolyte. This material may be applied to a surface of the electrode, behind the electrode, as one or more layers of a multilayer electrode, or throughout bulk of the electrode. The material may irreversibly react, may act as a catalyst, or may react reversibly to oxidize gas back into the electrolyte. For example, the material may be a recombination catalyst, such as, for example, tungsten carbide or palladium. The material may include, for example, a metal, an oxide, a suboxide, a hydroxide, a peroxide, an oxide hydroxide, an oxychloride, an oxynitrate, a carbonate, a nitride, a carbide, a polymer, or a combination thereof of one or more members selected from the group consisting of hydrogen, lithium, boron, carbon, nitrogen, oxygen, lignin, sulfur, sodium, magnesium, aluminum, silicon, potassium, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, lead, bismuth, and combinations thereof.

In some embodiments, the electrode may include (e.g., be made of) particles (e.g., capable of performing any one or more of the aforementioned functions) combined with one or more binders. The one or more binders may include, for example, polyvinylidene fluoride (PVDF), polytetrafluoroethylene (PTFE), polyvinyl alcohol, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), styrene butadiene rubber (SBR), or a conductive additive, such as, for example, carbon black, acetylene black, carbon fibers, carbon nanotubes, graphene, graphite, a fullerene, a carbon aerogel, metal flakes, metal fibers, or metal particles.

### Conductive Substrate Electrodes Participating in or Supporting Electrochemical Reactions in an Aqueous Electrolyte for Energy Storage Systems

Provided herein are electrodes that can be used in electrochemical cells, such as aqueous secondary batteries. An electrochemical cell may include an anode, a cathode, a separator that prevents direct physical contact of the anode and the cathode, and an electrolyte. An electrochemical cell may include a battery, that has any one or more of a variety of form factors. For example, the electrochemical cell may be a pouch cell, a coin cell, a cylindrical cell, or a prismatic cell.

In some embodiments, an electrode initially comprises a conductive substrate (e.g., a current collector). For example, the electrode may include only a conductive substrate when uncycled (e.g., before charge and/or discharge of a cell, such as a half-cell, for example in situ or ex situ). The substrate may include a carbon-based material, such as, for example, a carbon-based foam, paper, aerogel, foil, or carbon-based fibers, particles, or nanostructures (e.g., rods and/or tubes), or a metal material, such as, for example, a metal-based foil, foam, sheet, mesh, or stock. In some embodiments, a conductive substrate includes a conductive film applied to a physical support. The physical support may include a carbon-based material, such as, for example, a carbon-based foam, paper, aerogel, foil, or carbon-based fibers, particles, or nanostructures (e.g., rods and/or tubes), or a metal material, such as, for example, a metal-based foil, foam, sheet, mesh, or stock. A conductive substrate may be used in the form of a powder or particles. In some embodiments, the powder or particles are sintered, coated, or otherwise deposited to form a structure such as a coating, foil, foam, sheet, mesh, or stock. The substrate may be deposited on another physical support which may include, for example, a carbon-based material such as, for example, a foam, paper, aerogel, or foil, or fibers, particles, or nanostructures (e.g., rods and/or tubes), or a metal material, such as, for example, a metal-based foil, foam, sheet, mesh, or stock. The physical support may include a polymeric material, such as, for example, polyvinylidene fluoride (PVDF), polytetrafluoroethylene (PTFE), polyvinyl alcohol, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), styrene butadiene rubber (SBR), polyaniline (PANI), polypyrrole (Ppyr), polystyrene (PS), or polythiophene (PT). Such a polymeric material may be incorporated into an electrode ex situ (e.g., during synthesis or assembly of the electrode) or in situ (e.g., by chemical or electrochemical deposition onto the electrode during cycling), or some combination thereof. The conductive substrate may be templated to increase surface area.

A conductive substrate may act as a surface upon which a material can change its redox state during operation of an electrochemical cell (e.g., battery). For example, a material might deposit or dissolve on the conductive substrate during cycling of the electrochemical cell. The electrode might also act as a surface upon which material may deposit and then undergo further one or more electrochemical reactions including conversion from one compound to a second along with any associated intermediate(s), monovalent or multivalent monatomic or polyatomic ion intercalation or storage, structural rearrangement, or other redox mechanisms not otherwise listed.

A conductive substrate may also include one or more other active or inert materials. Suitable materials include metals, oxides, suboxides, hydroxides, oxide hydroxides, oxychlorides, oxynitrates, carbonates, nitrides, carbides, sulfides, halides, polymers, and combinations thereof of one or more of, lithium, boron, carbon, nitrogen, oxygen, sulfur, sodium, magnesium, aluminum, silicon, potassium, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, bismuth, and combinations thereof. These materials may have the form of flakes, pellets, powders, particles, tubes, cubes, fibers, or include a combination thereof.

A material deposited on a conductive substrate (e.g., during electrochemical cycling) may include a material selected from: oxides of, suboxides of, oxychlorides of, oxynitrates of, hydroxides of, sulfides of, halides of, hydrides of, carbides of, oxide hydroxides of, and elemental forms of titanium, vanadium, chromium, manganese, iron, aluminum, silicon, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, bismuth, and combinations thereof. The material deposited may be of any suitable crystal phase or structure, crystallinity, or ratio of metal atoms to oxygen atoms. There may be multiple materials that deposit on the substrate each with different crystal phases, crystallinities, and/or oxygen contents. Multiple materials may deposit to form a solid solution. Material may also deposit within a hosting material in the electrode substrate by such a mechanism that includes, but is not limited to, deposition as a discrete phase in internal volume of a separate material, intercalation, or deposition within a lattice of the material. These deposited material(s) may be modified with hydrogen, lithium, boron, carbon, nitrogen, oxygen, sulfur, sodium, magnesium, aluminum, silicon, potassium, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, lead, bismuth, or some combinations thereof.

### Methods to Promote Current Collector Stability in Aqueous Electrolytes for Energy Storage Systems

Compositions and methods disclosed herein mitigate (e.g., prevent) one or more side-reactions or one or more electrochemically passivating reactions, or both of a current collector in an electrode (e.g., anode or cathode). The electrode may be included in an aqueous secondary battery, that includes an aqueous electrolyte. This section describes such compositions and methods.

In some embodiments, a current collector is coated with an electron permeable (e.g., electrically conductive) film that physically isolates the current collector from an electrolyte. In some embodiments, the current collector comprises a metal and the film physically isolates the metal from the electrolyte. In some embodiments, the film comprises an electrically conductive carbon (e.g., graphene and/or graphite). In some embodiments, the film includes one or more carbon-based materials. The carbon-based material(s) may include one or more electrically conductive materials and/or one or more non-electrically conductive materials. Suitable carbon-based materials include polyvinylidene fluoride (PVDF), polytetrafluoroethylene (PTFE), polyvinyl alcohol, polyvinylpyrrolidone (PVP), polyvinyl acetate, polyvinyl chloride (PVC), polyaniline (PANI), polypyrrole (Ppyr), polystyrene (PS), polythiophene (PT), carboxymethyl cellulose (CMC), hydroxypropyl cellulose (HPC), hydroxyethyl cellulose (HEC), styrene butadiene rubber (SBR), carbon black, acetylene black, carbon fibers, carbon nanotubes, graphene, graphite, fullerenes, and combinations thereof. The film may include one or more of silicon, a silicon oxide, titanium, a titanium oxide, vanadium, a vanadium oxide, chromium, a chromium oxide, manganese, a manganese oxide, magnesium, a magnesium oxide, lithium, a lithium oxide, sodium, a sodium oxide, potassium, a potassium oxide, iron, an iron oxide, cobalt, a cobalt oxide, nickel, a nickel oxide, copper, a copper oxide, zinc, a zinc oxide, aluminum, an aluminum oxide, gallium, a gallium oxide, zirconium, a zirconium oxide, niobium, a niobium oxide, molybdenum, a molybdenum oxide, ruthenium, a ruthenium oxide, silver, a silver oxide, cadmium, a cadmium oxide, indium, an indium oxide, tin, a tin oxide, antimony, an antimony oxide, lanthanum, a lanthanum oxide, cerium, a cerium oxide, neodymium, tantalum, a tantalum oxide, tungsten, a tungsten oxide, rhenium, a lead oxide, strontium, a strontium oxide, bismuth, and a bismuth oxide, halides, hydroxides, oxides, phosphates, suboxides, nitrates, nitrites, sulfates, sulfides, chlorates, bromates, iodates, and cyanides thereof, and combinations thereof. Any of the aforementioned materials may be modified (e.g., doped) by one or more of the following elements: boron, magnesium, silicon, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, lead, bismuth, and combinations thereof. The film may be formed ex situ or in situ (e.g., during electrochemical cycling).

In some embodiments, current collector(s) include (e.g., are modified with) one or more materials that release one or more ions. The one or more ions may react with exposed electrode material that appears during a current collector side-reaction process. The reaction may result in the formation of a solid precipitate that could reduce further side-reactions of the current collector. These ions may include ions of hydrogen, lithium, boron, sodium, magnesium, silicon, potassium calcium, vanadium, manganese, iron, cobalt, nickel, copper, zinc, gallium, strontium, zirconium, molybdenum, ruthenium, silver, cadmium, indium, tin, antimony, lanthanum, cerium, tantalum, tungsten, rhenium, bismuth, or a combination thereof. These ions may be released from materials including, but not limited to, metals, silicates, aluminum silicates, or silicon aluminum phosphates. These materials may be coated on the surface of one or more electrodes or incorporated into the bulk of one or more electrodes.

In some embodiments, a surface of a current collector is chemically or electrochemically modified, for example such that bulk current collector is isolated from an electrolyte. Electroactive material of an electrode (e.g., anode or cathode) may be disposed on the current collector. The modified surface may include one or more of: silicon, a silicon oxide, titanium, a titanium oxide, vanadium, a vanadium oxide, manganese, a manganese oxide, magnesium, a magnesium oxide, iron, an iron oxide, cobalt, a cobalt oxide, nickel, copper, zinc, a zinc oxide, aluminum, an aluminum oxide, gallium, a gallium oxide, zirconium, a zirconium oxide, niobium, a niobium oxide, molybdenum, a molybdenum oxide, ruthenium, a ruthenium oxide, silver, a silver oxide, tin, a tin oxide, antimony, an antimony oxide, tantalum, a tantalum oxide, tungsten, a tungsten oxide, rhenium, strontium, a strontium oxide, bismuth, and a bismuth oxide; halides, hydroxides, oxides, phosphates, suboxides, nitrates, nitrites, sulfates, sulfides, chlorates, bromates, iodates, and cyanides thereof; and combinations thereof. In some embodiments, a surface of a current collector includes an organometallic complex that includes one or more of (i) a metal or metal oxide and (ii) one or more anions. Suitable anions include carbonates, sulfates, sulfites, nitrates, nitrites, phosphates, phosphites, chromates, halides, amines, azides, acrylates, methacrylates, and hydroxides. In some embodiments, a surface of a current collector is modified with both one or more non-aluminum metals and one or more anions capable of forming an organometallic complex. In some embodiments, a surface of an electrode may include a polymer coating, such as, for example, polyaniline (PANI), polypyrrole (Ppyr), or polythiophene (PT).

In some embodiments, a current collector is in contact with a material capable of decreasing galvanic corrosion in an electrochemical cell (e.g., battery). This material may include a carbon-based material such as, for example, carbon black, acetylene black, carbon fibers, carbon nanotubes, graphene, graphite, or fullerenes. This material may include a metal, alloy, oxide, suboxide, sulfide, hydroxide, oxide hydroxide, oxychloride, oxynitrate, carbonate, nitride, or carbide that includes magnesium, silicon, calcium, titanium, vanadium, chromium, manganese, iron, cobalt, nickel, copper, zinc, gallium, zirconium, niobium, molybdenum, ruthenium, silver, cadmium, indium, tin, antimony, lanthanum, cerium, neodymium, tantalum, tungsten, rhenium, platinum, gold, lead, bismuth, or some combination thereof. This material may be disposed at a surface of a current collector or may be incorporated into the bulk on an electrode. For example, corrosion of a current collector can be mitigated if a small amount of an additional material is applied to a surface of the current collector (e.g., as a continuous or discontinuous film) and/or dispersed in bulk of the current collector (e.g., as in particle(s)). Such a material may be disposed in a form of one or more sheets, one or more foils, one or more flakes, one or more pellets, one or more powders, one or more particles, one or more fibers, or some combination thereof.

### Methods to Promote Aluminum Metal Stability in an Aqueous Electrolyte for Energy Storage Systems

Compositions and methods disclosed herein mitigate prevent one or more side-reactions or one or more electrochemically passivating reactions, or both of an aluminum metal anode. The aluminum metal anode may be included in an aqueous secondary battery. This section describes such compositions and methods.

In some embodiments, an electrode (e.g., metal anode) is coated with an electron permeable (e.g., electrically conductive) film that physically isolates the electrode from an electrolyte. In some embodiments, the film includes one or more carbon-based materials. Suitable carbon-based materials include polyvinylidene fluoride (PVDF), polytetrafluoroethylene (PTFE), polyvinyl alcohol, polyvinylpyrrolidone (PVP), polyvinyl acetate, polyvinyl chloride (PVC), polyaniline (PANI), polypyrrole (Ppyr), polystyrene (PS), polythiophene (PT), carboxymethyl cellulose (CMC), hydroxypropyl cellulose (HPC), hydroxyethyl cellulose (HEC), styrene butadiene rubber (SBR), carbon black, acetylene black, carbon fibers, carbon nanotubes, graphene, graphite, or fullerenes. In some embodiments, the film includes one or more silicon-based materials. Suitable silicon-based materials include silanes, siloxanes, silicates, silicides, silicon oxides, silicon aluminum phosphates, and silicon carbides. In some embodiments, the film includes one or more aluminum-based materials. Suitable aluminum-based materials include aluminum oxides and suboxides, aluminum phosphates, aluminum hydroxides, and aluminum oxide hydroxides. Any of the aforementioned materials may be modified by one or more of the following elements, including boron, magnesium, silicon, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, lead, bismuth, and combinations thereof. The film may be formed ex situ or in situ (e.g., during electrochemical cycling).

In some embodiments, an electrode (e.g., anode) include (e.g., are modified with) one or more materials that release one or more ions. The one or more ions may react with exposed electrode material that appears during an electrode passivation process. The reaction may result in the formation of a solid precipitate that could reduce further electrochemical passivation of the electrode. These ions may include ions of hydrogen, lithium, boron, sodium, magnesium, silicon, potassium calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, praseodymium, neodymium, samarium, europium, gadolinium, terbium, dysprosium, holmium, erbium, thulium, ytterbium, lutetium, tantalum, tungsten, rhenium, platinum, gold, lead, bismuth, actinium, thorium, protactinium, uranium, a combination thereof. These ions may be released from materials including, but not limited to, metals, silicates, aluminum silicates, or silicon aluminum phosphates. These materials may be coated on the surface of one or more electrodes or incorporated into the bulk of one or more electrodes.

In some embodiments, a surface of an electrode (e.g., an aluminum metal anode) is chemically or electrochemically, for example such that bulk electrode is isolated from an electrolyte. The modified surface may include one or more of: aluminum, oxygen, and another metal, such as boron, magnesium, silicon, calcium, titanium, vanadium, chromium, manganese, iron, cobalt, nickel, copper, zinc, gallium, germanium, rubidium, strontium, zirconium, niobium, molybdenum, ruthenium, silver, cadmium, indium, tin, antimony, lanthanum, cerium, neodymium, tantalum, tungsten, rhenium, platinum, gold, lead, bismuth, and combinations thereof. In some embodiments, the surface includes an organometallic complex that includes one or more of (i) a metal or metal oxide and (ii) one or more anions. Suitable anions include carbonates, sulfates, sulfites, nitrates, nitrites, phosphates, phosphites, chromates, halides, amines, azides, acrylates, methacrylates, and hydroxides. In some embodiments, the surface is modified with both one or more non-aluminum metals and one or more anions capable of forming an organometallic complex. In some embodiments, the surface may include a polymer coating, such as, for example, polyaniline (PANI), polypyrrole (Ppyr), or polythiophene (PT).

In some embodiments, a current collector is in contact with a material capable of decreasing galvanic corrosion in an electrochemical cell (e.g., battery). This material may include a carbon-based material such as, for example, carbon black, acetylene black, carbon fibers, carbon nanotubes, graphene, graphite, or fullerenes. This material may include a metal, alloy, oxide, suboxide, sulfide, hydroxide, oxide hydroxide, oxychloride, oxynitrate, carbonate, nitride, or carbide that includes magnesium, silicon, calcium, titanium, vanadium, chromium, manganese, iron, cobalt, nickel, copper, zinc, gallium, zirconium, niobium, molybdenum, ruthenium, silver, cadmium, indium, tin, antimony, lanthanum, cerium, neodymium, tantalum, tungsten, rhenium, platinum, gold, lead, bismuth, or some combination thereof. This material may be disposed at a surface of an electrode or may be incorporated into bulk of the electrode. Such a material may be disposed in a form of one or more sheets, one or more foils, one or more flakes, one or more pellets, one or more powders, one or more particles, one or more fibers, or some combination thereof.

### EXEMPLIFICATION

The following examples are provided as illustration and are not intended to be limiting with respect to any subject matter disclosed herein.

### Example 1: Reversible Ion Uptake and Release in a Cerium Oxide-Based Transition Metal Oxide Electrode

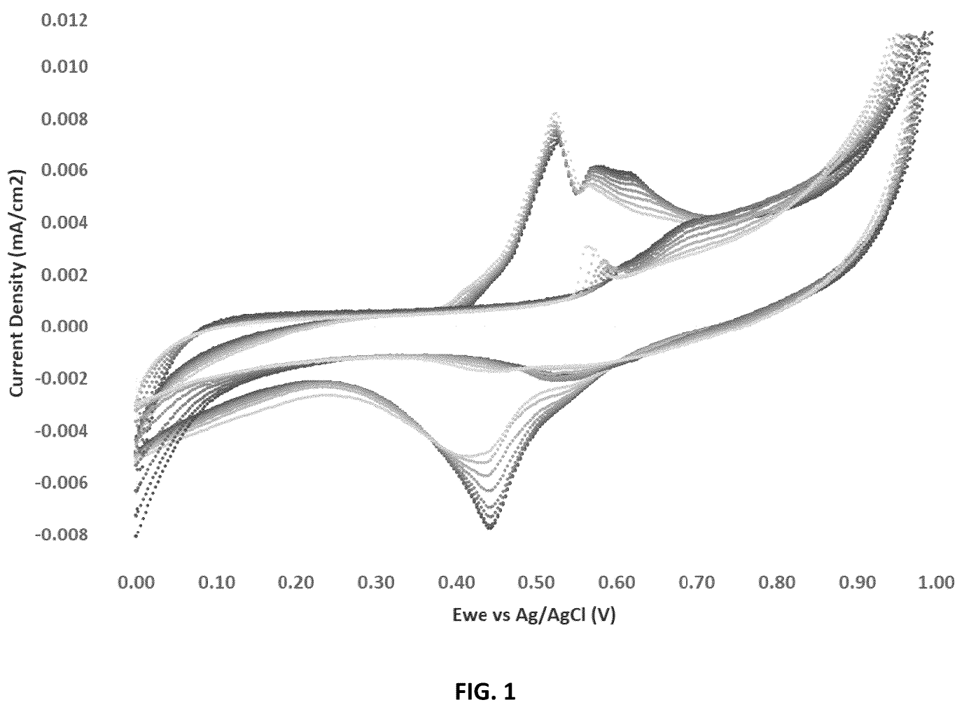

The present example demonstrates that a cerium oxide-based transition metal oxide electrode provides for reversible ion uptake and release during cycling of an electrochemical cell comprising the electrode, as demonstrated in FIG. 1. Platinum was used as the counter electrode and Ag/AgCl was used as the reference electrode. The voltage window was 0-1 V and the voltage sweep rate was 1 mV per second. The electrolyte had a pH of about 6 and the working ions were identified to be one or both of sodium (Na⁺) and protons (H⁺). Without being bound by any particular theory, the electrochemical reactions during cycling can broadly be described as one or more of the following:

Ce(IV)O₂+H⁺¹+1e⁻→Ce(III)HO₂ Formula 1

Ce(IV)O₂+Na⁺¹+1e⁻→Ce(III)NaO₂ Formula 2

2Ce(IV)O₂+Na⁺¹+H⁺¹+2e⁻→2Ce(III)H_{0.5}Na_{0.5}O₂ Formula 3

### Example 2: Reversible Ion Uptake and Release in a Bismuth Vanadate-Based Mixed Metal Oxide Electrode

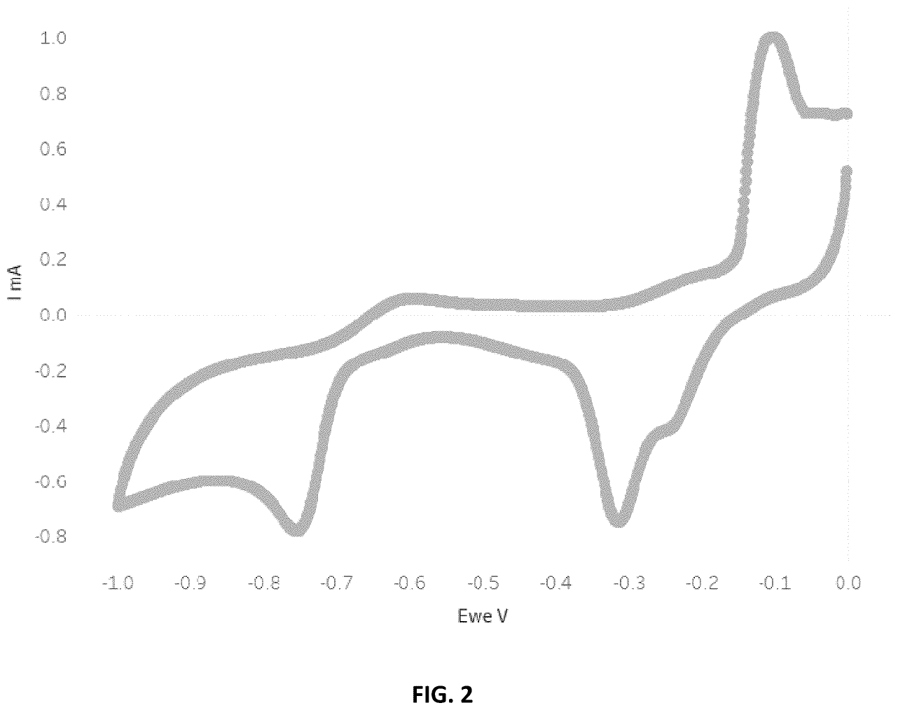

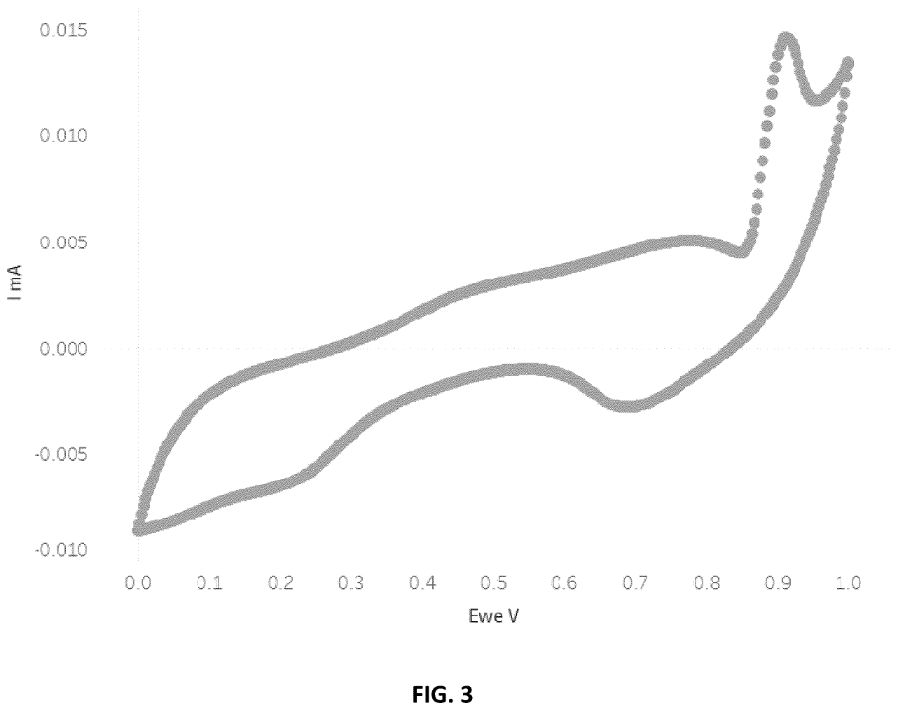

The present example demonstrates that a bismuth vanadate-based mixed metal oxide electrode provides for reversible ion uptake and release during cycling of an electrochemical cell comprising the electrode, as demonstrated in FIG. 2. Platinum was used as the counter electrode and Ag/AgCl was used as the reference electrode. The voltage window was 0-1 V and the voltage sweep rate was 1 mV per second. The electrolyte had a pH of about 3 and the working ions were identified to be one or both of sodium (Na⁺) and protons (H⁺).

### Example 3: Reversible Ion Uptake and Release in a Manganese Tungstate-Based Mixed Metal Oxide Electrode

The present example demonstrates a manganese tungstate-based mixed metal oxide electrode provides for reversible ion uptake and release during cycling of an electrochemical cell comprising the electrode. Platinum was used as the counter electrode and Ag/AgCl was used as the reference electrode. The voltage window was 0-1 V and the voltage sweep rate was 1 mV per second. The electrolyte has a pH of about 3 and the working ions were identified to be one, both, or all of sodium (Na⁺), manganese (Mn⁵⁺, Mn⁴⁺, Mn³⁺, Mn²⁺) and protons (H⁺). The manganese tungstate-based mixed metal oxide electrode can also exhibit manganese deposition and dissolution reactions or proton-assisted manganese deposition and dissolution reactions. The transition metals in the cathode, i.e. manganese and tungsten, can exist in oxidation states of +5, +4, +3, +2 and +6, +5, +4, respectively, which is associated with ion uptake or release.

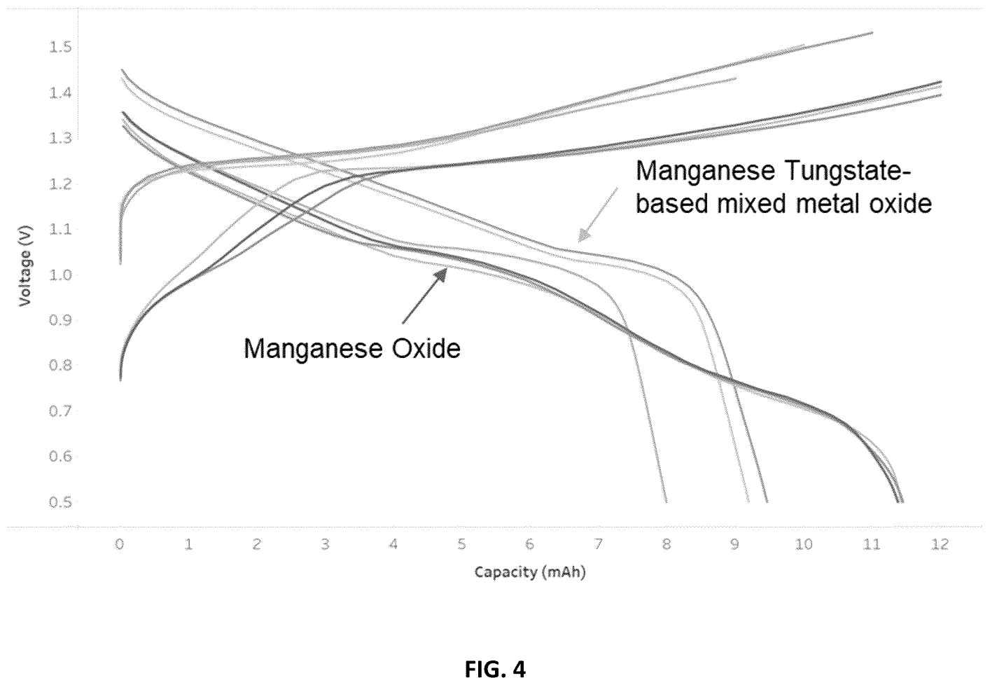

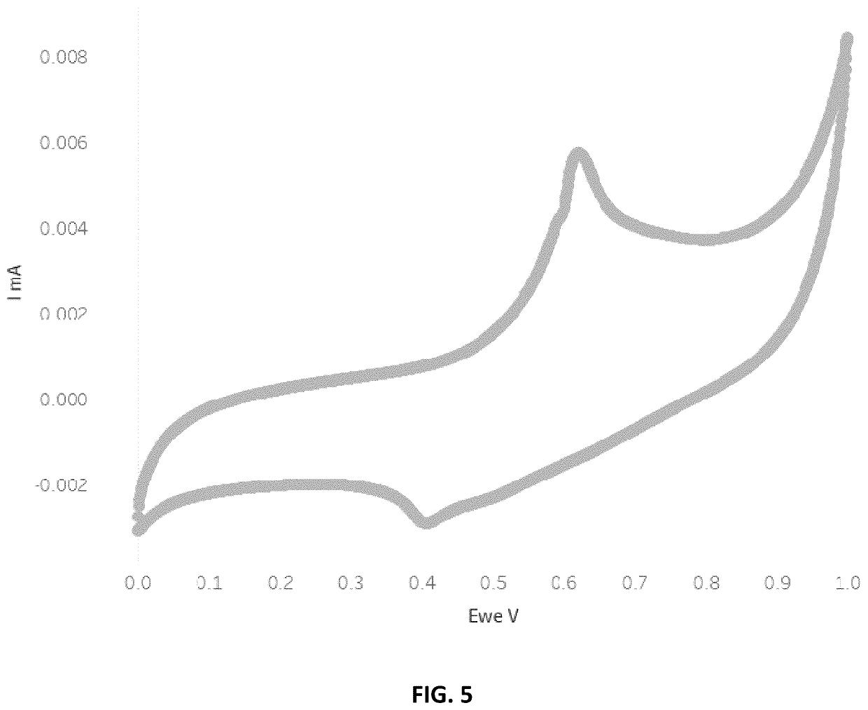

The present example further demonstrates that electrochemical cells comprising a manganese tungstate-based mixed metal oxide display a higher average nominal discharge voltage, compared to the cells using manganese oxide-based electrodes, demonstrated in FIG. 4 across three replicate cells for each electrode. The electrolyte included in the cells was a combination of one or more of potassium sulfate, sodium sulfate, manganese sulfate, aluminum sulfate, sulfuric acid and was mildly acidic. The cells were cycled in a pouch cell configuration at a rate of C/5 for a period of time of 5 hours for charge and discharge.

### Example 4: Reversible Ion Uptake and Release in a Manganese Tungstate-Based Mixed Metal Oxide Electrode

The present example demonstrates a manganese tungstate-based mixed metal oxide electrode provides for reversible ion uptake and release during cycling of an electrochemical cell. Platinum was used as the counter electrode and Ag/AgCl was used as the reference electrode. The voltage window was 0-1 V and the voltage sweep rate was 1 mV per second. The electrolyte had a pH of about 6 and the working ions were identified to be one, two, or all of sodium (Na⁺), manganese (Mn⁵⁺, Mn⁴⁺, Mn³⁺, Mn²⁺) and protons (H⁺). The manganese tungstate-based mixed metal oxide electrode exhibited manganese deposition and dissolution reactions or proton-assisted manganese deposition and dissolution reactions. Without wishing to be bound by any particular theory, at a higher pH, one or more of the electrochemical reactions comprising protons as the working ions or proton-assisted manganese deposition-dissolution may be suppressed. However, the electrode structure itself may be less prone to dissolution, thereby improving cycling stability. The transition metals in the cathode, i.e. manganese and tungsten, can exist in oxidation states of +5, +4, +3, +2 and +6, +5, +4, respectively, which is associated with ion uptake or release.

### Example 5: In-Operando X-Ray Diffraction (XRD) of a Tungsten-Based Metal Oxide Anode Cycling in an Acidic Aqueous Electrochemical Environment

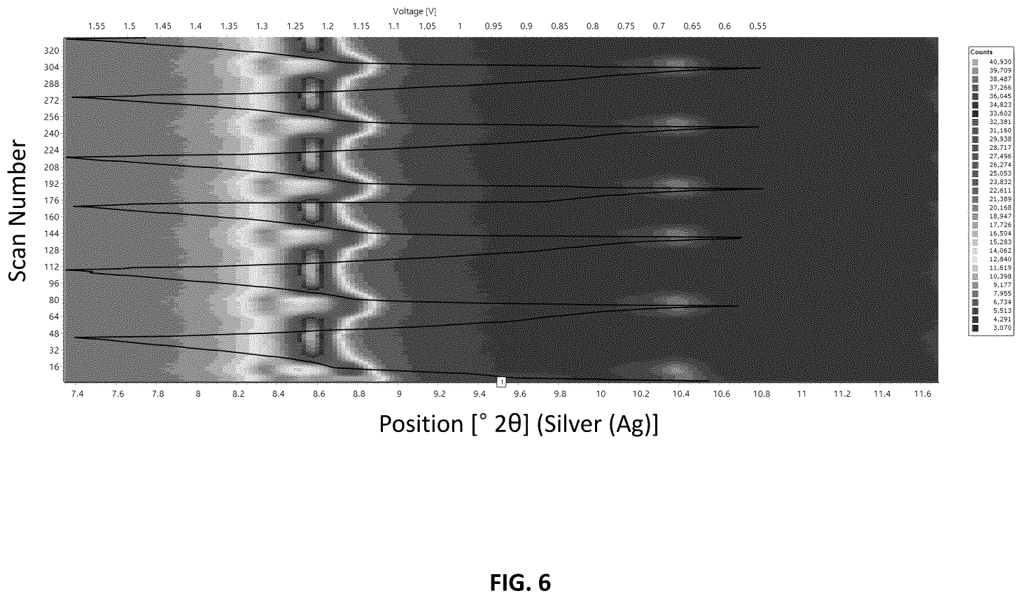

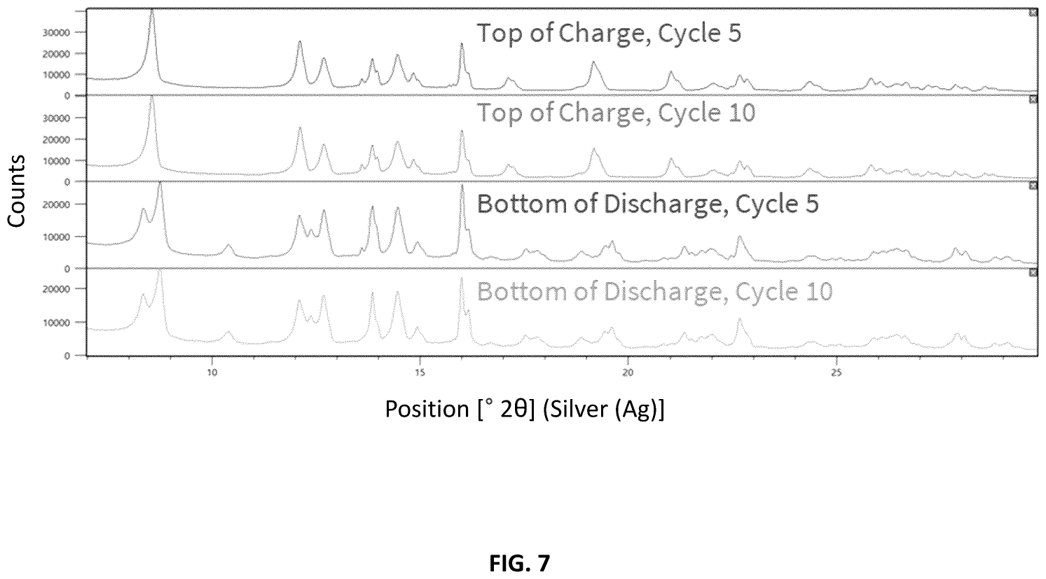

The present example demonstrates minor lattice expansion of tungsten-based metal oxide anode during cycling in an acidic aqueous electrochemical environment, presented in FIG. 6 and FIG. 7. Comparing the diffraction profiles between top of charge and bottom of discharge at different cycling stages in FIG. 7, it is evident that the material is capable of reversible ion uptake and release. Based on the electrochemical environment, that is the cationic composition in the electrolyte, the working ions were identified to be one or both of sodium (Na⁺) and protons (H⁺).

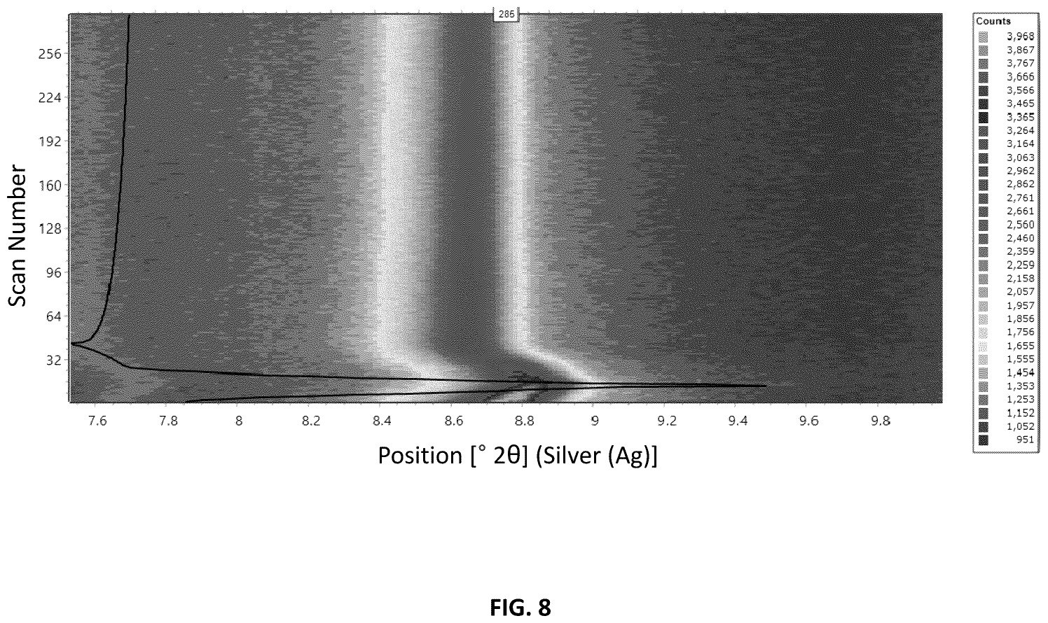

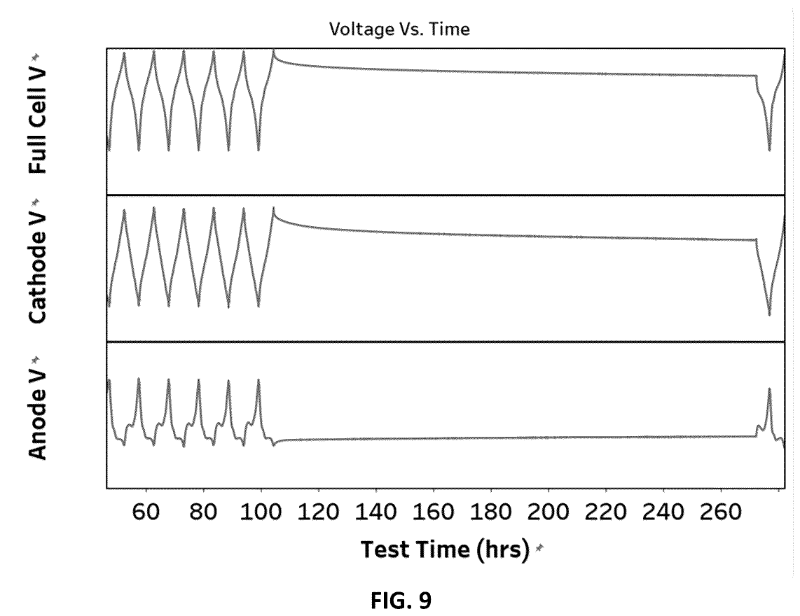

Further, self-discharge measurements were conducted at a 100% state of charge in a three-electrode pouch cell form factor. As presented in FIG. 8 and FIG. 9, the tungsten-based metal oxide anode was determined to be very stable, with no contraction of the d-spacing during rest. These results further validate the minor lattice shift was associated with reversible electrochemical insertion and extraction of ion and eliminates the possibility of any side reactions during electrochemical cycling.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

1.-11. (canceled)

12. A battery comprising: two electrodes comprising an anode and a cathode, an electrolyte, and a separator disposed to prevent direct physical contact of the anode and the cathode, wherein the electrolyte transfers ions between one or both of the electrodes during electrochemical cycling of the battery.

13. The battery of claim 12, wherein (i) the two electrodes exchange one or more same types of ions with the electrolyte as each other during the electrochemical cycling (ii) the two electrodes exchange one or more different types of ions with the electrolyte from each other during the electrochemical cycling or (iii) a combination of (i) and (ii).

14. The battery of claim 13, wherein the one of the two electrodes is in a relatively less acidic environment at a stage of charge and the other of the two electrodes is in a relatively more acidic environment at the stage of charge.

15. The battery of claim 14, wherein the relatively less acidic environment is a neutral environment or an alkaline environment and the relatively more acidic environment is a neutral environment or an acidic environment.

16.-19. (canceled)

20. The battery of claim 12, wherein the electrolyte comprises one or more ions that promote diffusion of at least one other ion into at least one of the two electrodes, wherein the at least one other ion is an electroactive species.

21. The battery of claim 12, wherein the electrolyte comprises an additive that (1) promotes hydrogen evolution reaction, (2) impedes hydrogen evolution reaction, (3) promotes oxygen evolution reaction, (4) impedes oxygen evolution reaction, (5) promotes dissolution species from one or both the electrodes, (6) impedes dissolution species from one or both the electrodes, (7) promotes stripping and plating of metal ions, (8) impedes stripping and plating of metal ions, (9) promotes conversion between metals and metal oxides, or (10) impedes conversion between metals and metal oxides.

22. The battery of claim 12, wherein at least one of the two electrodes comprises one or more materials selected from the group consisting of: elemental forms of a metal, halides of a metal, hydroxides of a metal, oxides of a metal, phosphates of a metal, suboxides of a metal, nitrates of a metal, nitrites of a metal, sulfates of a metal, sulfides of a metal, chlorates of a metal, bromates of a metal, cyanides of a metal, and iodates of a metal.

23. The battery of claim 22, wherein the metal is selected from the group consisting of silicon, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, neodymium, tantalum, tungsten, mercury, rhenium, platinum, gold, lead, strontium, bismuth, and combinations thereof.

24. The battery of claim 12, wherein at least one of the two electrodes comprises a metal selected from the group consisting of silicon, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, neodymium, tantalum, tungsten, rhenium, platinum, gold, lead, strontium, bismuth, and combinations thereof.

25. The battery of claim 12, wherein at least one of the two electrodes comprises a metal oxide selected from the group consisting of silicon oxides, titanium oxides, vanadium oxides, chromium oxides, manganese oxides, magnesium oxide, lithium oxides, sodium oxides, potassium oxides, iron oxides, cobalt oxides, nickel oxides, copper oxides, zinc oxides, aluminum oxides, gallium oxides, zirconium oxides, niobium oxides, molybdenum oxides, ruthenium oxides, silver oxides, cadmium oxides, indium oxides, tin oxides, antimony oxides, lanthanum oxides, cerium oxides, tantalum oxides, tungsten oxides, lead oxides, strontium oxides, bismuth oxides, ternary oxide comprising one or more of silicon, calcium, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, tantalum, tungsten, lead, strontium, and bismuth, quaternary oxides comprising one or more of silicon, calcium, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, tantalum, tungsten, lead, strontium, and bismuth and combinations thereof.

26. The battery of claim 12, wherein at least one of the two electrodes comprises a material comprising one or more additives comprising one or more elements, one or more dopants comprising one or more elements, one or more interstitial alloys comprising one or more elements, one or more interstitial compounds comprising one or more elements, one or more chemical bonds with one or more elements, or one or more physical bonds with one or more elements.

27. The battery of claim 26, wherein the one or more elements comprises an element selected from the group consisting of hydrogen, boron, carbon, nitrogen, sodium, potassium, lithium, calcium, sulfur, phosphorus, manganese, magnesium, iron, cobalt, nickel, copper, zinc, aluminum, gallium, zirconium, niobium, molybdenum, ruthenium, cadmium, indium, tin, antimony, lanthanum, cerium, neodymium, tantalum, tungsten, rhenium, platinum, lead, strontium, bismuth, and halides.

28. The battery of claim 12, wherein at least one of the two electrodes comprises a material comprising defects, vacancies, moieties, or holes.

29. The battery of claim 28, wherein the at least one of the two electrodes has been treated to introduce the defects, vacancies, moieties, or holes.

30. The battery of claim 12, wherein at least one of the two electrodes comprises a material comprising water molecules and/or one or more anions and/or one or more functional groups with or without a physical or chemical bonding.

31.-32. (canceled)

33. The battery of claim 12, wherein at least one of the two electrodes exist in the form of an alloy, a mixed metal oxide, or composite wherein the alloy, the mixed metal oxide, or the composite is formed with one or more members selected from the group consisting of: carbon, a carbide, silicon, a silicon oxide, titanium, a titanium oxide, vanadium, a vanadium oxide, chromium, a chromium oxide, manganese, a manganese oxide, magnesium, a magnesium oxide, lithium, a lithium oxide, sodium, a sodium oxide, potassium, a potassium oxide, iron, an iron oxide, cobalt, a cobalt oxide, nickel, a nickel oxide, copper, a copper oxide, zinc, a zinc oxide, aluminum, an aluminum oxide, gallium, a gallium oxide, zirconium, a zirconium oxide, niobium, a niobium oxide, molybdenum, a molybdenum oxide, ruthenium, a ruthenium oxide, silver, a silver oxide, cadmium, a cadmium oxide, indium, an indium oxide, tin, a tin oxide, antimony, an antimony oxide, lanthanum, a lanthanum oxide, cerium, a cerium oxide, neodymium, tantalum, a tantalum oxide, tungsten, a tungsten oxide, rhenium, platinum, gold, lead, a lead oxide, strontium, strontium oxide, bismuth, and a bismuth oxide.

34. The battery of claim 12, wherein the battery is a secondary battery.

35. The battery of claim 12, wherein the electrolyte is an aqueous electrolyte such that the battery is an aqueous battery.

36. A method of operating a battery comprising an electrode comprising a conductive substrate, the method comprising changing a redox state of a material on the substrate during electrochemical cycling of the battery.

37. The method of claim 36, comprising depositing and/or dissolving the material on the substrate during the electrochemical cycling.

38.-134. (canceled)
